(19) United States
(12) Patent Application Publication
(10) Pub. No.: US 2024/0198288 A1
(43) Pub. Date: Jun. 20, 2024

(54) SUSTAINABLE DESALINATION SYSTEMS AND METHODS USING RECYCLED BRINE STREAMS

(71) Applicant: Enviro Water Minerals Company, Inc., Houston, TX (US)

(72) Inventor: Paul Steven Wallace, Austin, TX (US)

(21) Appl. No.: 18/556,824

(22) PCT Filed: Apr. 22, 2022
(86) PCT No.: PCT/US22/25985

§ 371 Date: Oct. 23, 2023

Related U.S. Application Data
(60) Provisional application No. 63/178,941, filed on Apr. 23, 2021.

(51) Int. Cl. B01D 61/08; B01D 61/02; B01D 61/04; C01B 17/74; C01D 3/06; C01F 5/14; C01F 5/30; C02F 1/44; C02F 1/52; C02F 9/00; C02F 101/12; C02F 103/08

(52) U.S. Cl. CPC B01D 61/08; B01D 61/029; B01D 61/04; C01B 17/74; C01D 3/06; C01F 5/14; C01F 5/30; C02F 9/00; B01D 61/025; B01D 61/027; B01D 61/0271; B01D 2311/08; B01D 2317/025; C02F 1/441; C02F 1/442; C02F 2001/5218; C02F 1/5245; C02F 2101/12; C02F 2103/08; C02F 2301/046

(57) ABSTRACT

The present disclosure is generally directed to a desalination system. In some embodiments, the desalination system includes one or more recycle seawater systems configured to receive one or more concentrated brine streams produced by the desalination system and generate one or more recycle brine streams using the one or more concentrated brine streams and desalinated water.

### CROSS REFERENCE TO RELATED APPLICATION

This application is a national stage of PCT Application No. PCT/US22/25985, entitled “Sustainable Desalination Systems and Methods Using Recycled Brine Streams”, filed Apr. 22, 2022, which claims priority from and the benefit of U.S. Provisional Patent Application No. 63/178,941, entitled “Sustainable Desalination Systems and Methods Using Recycled Brine Streams,” filed Apr. 23, 2021. The foregoing application is hereby incorporated by reference in its entirety.

### BACKGROUND

The subject matter disclosed herein generally relates to a system for sustainable water desalination, and more specifically, to techniques for using waste brine to generate additional chemicals.

There are several regions in the United States (e.g., the southwestern United States including New Mexico, Southern California, and parts of Texas) and throughout the world that experience shortages in potable water supplies due, in part, to the arid climate of these geographic locales. As water supplies are limited, innovative technologies and alternative water supplies for both drinking water and agriculture may be utilized. One method for obtaining an alternative source of potable water uses desalination systems to produce the potable water.

The desalination process may involve the removal of salts from seawater, agricultural run-off water, and/or brackish ground water brines to produce potable water. Membrane-based desalination may use an assortment of filtration methods, such as nanofiltration and reverse osmosis, to separate the raw brine stream into a desalinated water stream and tailing streams. The tailing streams may contain various salts and other materials left over after the desalination process. Included in these tailing streams may be valuable salts and minerals which may be extracted using membrane-based and/or evaporative techniques.

### BRIEF DESCRIPTION

The present disclosure generally relates to a system including a water pretreatment system that receives a seawater stream and generates a pretreated feed stream based on the seawater stream. The system also includes a nanofiltration (NF) system that receives the pretreated feed stream and generates an NF permeate stream and an NF filtrate stream, wherein the NF permeate stream comprises monovalent salts, and the NF filtrate stream comprises divalent salts. Additionally, the system includes a reverse osmosis (RO) system that receives the NF permeate stream and to generate a RO concentrate stream and desalinated water. Further, the system includes a monovalent (MV) mineral recovery system that receives the RO concentrate stream and generates a concentrated MV salt recycle stream. Further still, the system includes a recycle seawater that generates a recycle seawater stream based on the MV salt recycle stream, wherein the recycle seawater system directs the recycle seawater stream to the NF system.

In some embodiments, the present disclosure relates to a system including a water pretreatment system that receives a seawater stream and generates a pretreated feed stream based on the seawater stream. The system also includes a nanofiltration (NF) system that receives the pretreated feed stream. The NF system includes first NF unit that generates an NF permeate stream and an NF filtrate stream based on the pretreated feed stream, wherein the NF permeate stream comprises monovalent (MV) salts, and the NF filtrate stream comprise polyvalent (PV) salts. The NF system also includes a second NF unit that receives the NF filtrate stream and generates an NF recycle stream, wherein the second NF unit directs the NF recycle stream upstream of the first NF unit. Additionally, the system includes a reverse osmosis (RO) system that receives the NF permeate stream and to generate an RO concentrate stream and desalinated water. Further, the system includes a monovalent (MV) mineral recovery system that receives the RO concentrate stream and generates a concentrated MV salt recycle stream. Further still, the system includes a recycle seawater system that generates a recycle seawater stream based on the MV salt recycle stream, wherein the recycle seawater system directs the recycle seawater stream to upstream of the first NF unit.

In some embodiments, the present disclosure relates to a system that includes a water pretreatment system that receives a seawater stream and generates a pretreated feed stream based on the seawater stream. The system also includes a nanofiltration (NF) system that receives the pretreated feed stream and to generate a monovalent (MV) salt stream and a polyvalent (PV) salt stream, wherein the PV salt stream comprises calcium and sulfate ions. Additionally, the system includes a gypsum recovery system that receives the PV salt stream and generates gypsum and a PV salt recycle stream. Further, the system includes a recycle seawater system that generates a recycle seawater stream based on the PV salt recycle stream, wherein the recycle seawater system directs the recycle seawater stream to the NF system.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an embodiment of a desalination system, in accordance with aspects of the present disclosure;

FIG. 2 is a block diagram of an embodiment of a recycle seawater system that may be used in the desalination system of FIG. 1, in accordance with the present techniques;

FIG. 3 is a block diagram of an embodiment of an nanofiltration (NF) permeate recycle seawater system that may be used in the desalination system of FIG. 1, in accordance with the present techniques;

FIG. 4 is block diagram of an embodiment of a Seawater Reverse Osmosis (SWRO) Concentrate Brine Concentrator that may be used in the desalination system of FIG. 1, in accordance with the present techniques;

FIG. 5 is schematic diagram of an embodiment of a boric acid recovery system, in accordance with the present techniques;

FIG. 6 is a schematic diagram of an embodiment of a magnesium chloride drying system, in accordance with the present techniques;

FIG. 7 is a schematic diagram of an embodiment of a chlorine scrubber system, in accordance with the present techniques;

FIG. 8A is a schematic diagram of a first portion of an embodiment of a bromine recovery system, in accordance with the present techniques;

FIG. 8A is a schematic diagram of second portion of an embodiment of a bromine recovery system, in accordance with the present techniques;

FIG. 9 is a block diagram of an embodiment of a monovalent (MV) tail brine system, in accordance with the present techniques;

FIG. 10 is a block diagram of an embodiment of a potassium sulfate generation system, in accordance with the present techniques;

FIG. 11 is a schematic diagram of an embodiment of a first example of a multieffect crystallizer system, in accordance with the present techniques;

FIG. 12 is a schematic diagram of an embodiment of a second example of a multieffect crystallizer system, in accordance with the present techniques;

FIG. 13 is a schematic diagram of an embodiment of a magnesium chloride (MgCl₂) filter system, in accordance with the present techniques; and

FIG. 14 is a flow diagram of an embodiment of a method for generating one or more recycle seawater streams, in accordance with the present techniques.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Arid regions of the world may utilize desalination systems to provide fresh water, to provide building cooling for climate control, and to provide refrigeration to prevent food spoilage. It may be desirable to use renewable non-CO₂ emitting power sources (e.g., wind and solar power) for these demands; however the low availability of the renewable power sources creates a reliability problem. Desalination systems, such as those with mineral recovery, may operate 24/7 in order to enhance water and byproduct minerals revenue from the large fixed capital investment. In addition, the associated commercial and residential power demand for building cooling and refrigeration in the community surrounding the desalination system is highly variable and impacts power available for desalination. Typically, excess power is available in the winter when there is no air conditioning load. Power may be stored in batteries for electrical grid consumption; however; battery storage may be cost effective for a relatively short time period (e.g., less than 4 hours). Cloudy or low wind conditions may occur for several consecutive days even in arid and windy regions of the world.

Concentrated Solar Power (CSP) system with molten salt storage and cogeneration of steam and power may provide a cost competitive method of providing low pressure steam for steam based thermal desalination and power for membrane and compressor/heat pump (e.g., Mechanical Vapor Recompression (MVR)) based thermal desalination. This avoids solar heat lost to a condenser while still converting 25-30% of the solar energy to high value power. In addition, excess wintertime solar power or emergency backup fossil fuel based power may be used to supplement the reduced wintertime solar heat availability.

The cost profile of various desalination processes show that steam based processes may be economically favorable when low cost steam is available from a CSP cogen system with thermal storage. However, power based processes may be more efficient and could be more economical if grid storage batteries become cheaper. Thus, there is a need for a full recovery desalination system design that may be configured for either low cost photovoltaic power with low cost grid battery storage with a high power demand (e.g., greater than approximately 90% of the energy requirement) or a CSP cogen system with a high steam demand (e.g., approximately 65-75% of the energy requirement) and low power demand (e.g., approximately 25-35% of the energy requirement).

Furthermore, it may be undesirable to dispose or reject waste brine to the ocean. Accordingly, there is a need for a recycle seawater system that collects, treats, and blends the various waste brine streams from full recovery desalination to create a near seawater quality stream, thereby enabling the waste brine to be recycled back to the desalination system as feed seawater.

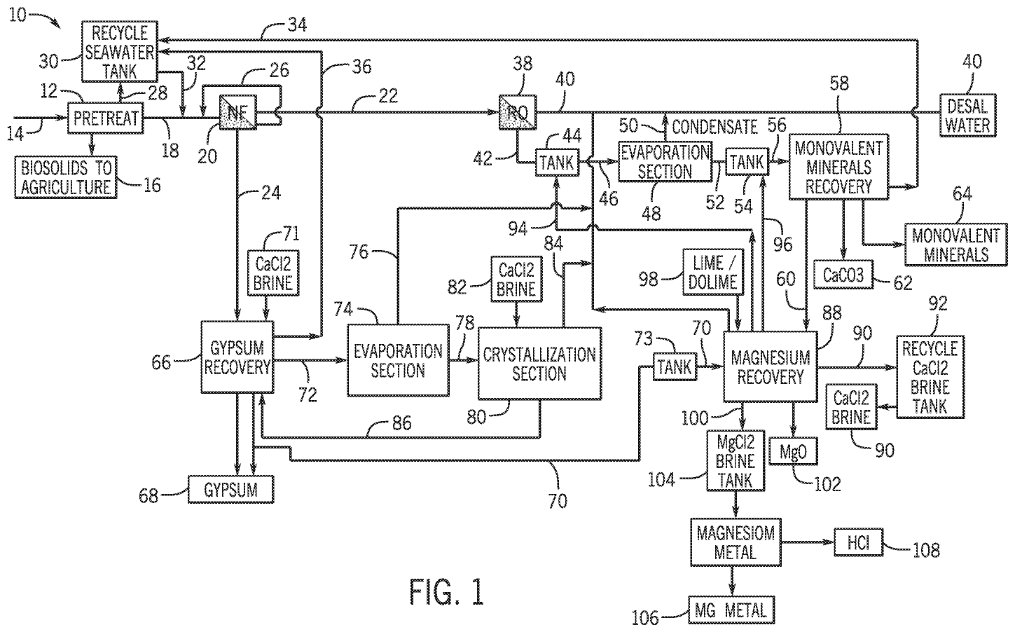

Accordingly, the present disclosure relates to techniques for reducing the rejection of brine in an energy efficient manner. With this in mind, FIG. 1 is a block diagram of an embodiment of a desalination system 10 (e.g., full recovery desalination system) that includes one or more recycle seawater systems to recycle waste brine. Additionally, the desalination system may output desalinated water, acid (e.g., HCl), and one or more minerals such as gypsum, monovalent minerals, magnesium oxide, and magnesium chloride.

In the illustrated embodiment, the water processing system 10 includes a pretreatment system 12 configured to receive a feed stream 14 (e.g., seawater). The feed stream 14 may be received from any suitable water source. For example, in certain embodiments, the feed stream 14 may be from a hydrocarbon extraction process (e.g., produced water). In other embodiments, the feed stream 14 may be received from ground water, seawater, brackish water, and so forth. The feed stream 14 may contain various elements and/or compounds. For example, the feed stream 14 may contain sodium chloride (NaCl), sulfate (SO₄), calcium (Ca), magnesium (Mg), bromine (Br₂), boron (B), silicon dioxide (silica or SiO₂), or a combination thereof. In certain embodiments, the feed stream 14 may contain approximately 0.50 g/L (500 ppm) to approximately 350.00 g/L (350,000 ppm) NaCl, approximately 0.010 g/L (10 ppm) to approximately 1.50 g/L (1,500 ppm) SO₄, approximately 0.01 g/L (10 ppm) to approximately 8.0 g/L (8000 ppm) Ca, Mg, and Ba, approximately 0.001 g/L (1 ppm) to approximately 0.1 g/l (100 ppm) B(OH)3, approximately 0.01 (10 ppm) g/L to approximately 1 g/L (1000 ppm) HCO3, approximately 0.01 g/L (10 ppm) to approximately 0.30 g/L (300 ppm) SiO₂, or a combination thereof. Furthermore, in certain embodiments, the feed stream 14 may have a pH range between approximately 5 and 9. For example, the feed stream 14 may have a pH of approximately 8.

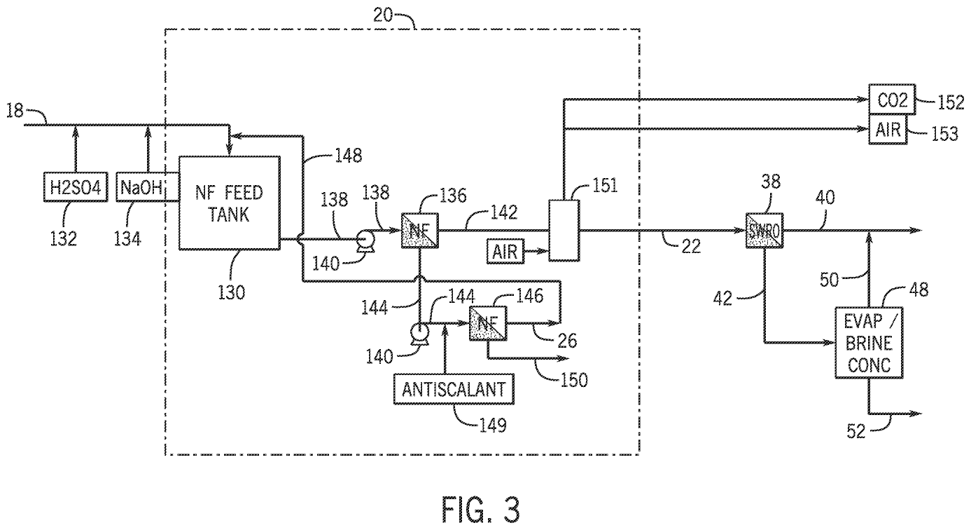

The pretreatment system 12 receives the feed stream 14 and removes solid materials (e.g., biosolids 16), from the feed stream 14. The pretreatment system 12 provides a pretreated feed stream 18 to an NF system 20. In general, the NF system 20 may generate a monovalent (MV) brine stream 22 (e.g., NF permeate stream) and a polyvalent (PV) brine stream 24 (e.g., a divalent (DV) brine stream and/or an NF concentrate stream). The MV brine stream 22 may include relatively low amounts of calcium, magnesium, and sulfate content as compared to the PV brine stream 24. The PV brine stream 24 may include relatively low amounts of sodium and chloride content as compared to the MV brine stream 22. In some embodiments, and as described in more detail with respect to FIG. 3, the NF system 20 may include one or more NF filters, which may provide a cost effective technique for separating the seawater into these two streams (e.g., the MV brine and the DV and/or PV brine). In some embodiments, a NF permeate recycle stream 26 may be directed to a location upstream of the NF system 20. It is presently recognized that redirecting the internal NF permeate recycle (e.g., NF Perm Recycle, as described in more detail with respect to FIG. 3) and/or the recycle seawater back to the NF system 20 (e.g., an NF feed tank of the NF system 20) may enhance the sharpness of the splitting between the MV and PV species present in the pretreated feed stream 18. That is, increasing the amount of NF permeate recycle stream 26 to the NF feed tank of the NF feed system 20 may decrease an amount of divalent salts (e.g., containing Ca or Mg) in the MV brine stream 22 and/or an amount of monovalent salts (e.g., containing Na) in the DV or PV brine (e.g., the PV brine stream 24). It should be noted that downstream removal of monovalent ions in the divalent brine and removal of divalent ions in the monovalent brine is significantly more expensive than an improved NF membrane brine separation.

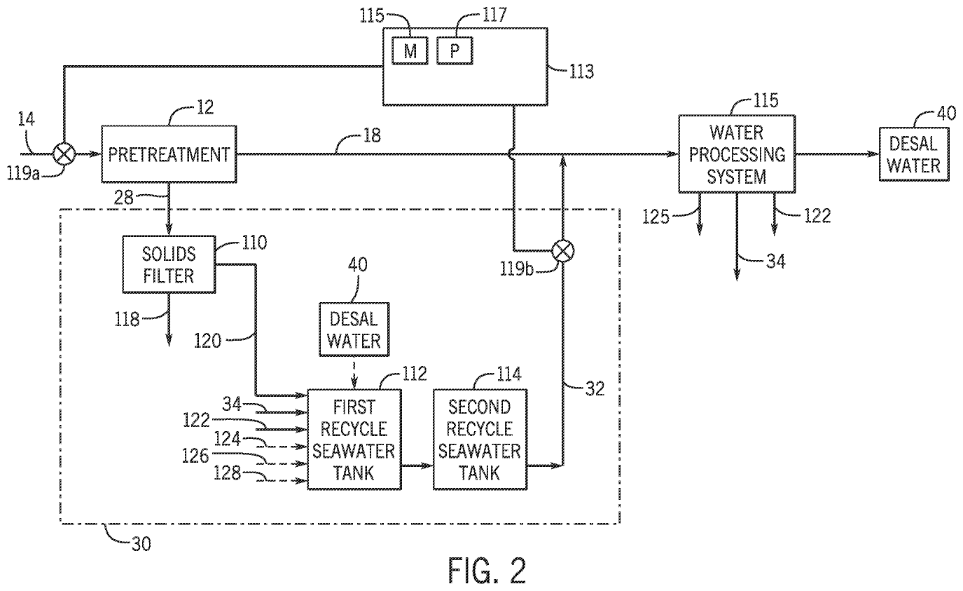

The pretreatment system 12 may also generate a pretreated backwash stream 28 and provide the pretreated backwash stream 28 to a recycle seawater system 30. In general, the recycle seawater system 30 (e.g., the recycle seawater blending and storage system including the recycle seawater tank and a first recycle seawater system), may provide a recycle seawater stream 32 to the NF system 20 to avoid, reduce, or prevent periodic waste brine disposal to the ocean. For example, as shown in the illustrated embodiment, the recycle seawater system 30 receives a MV recycle stream 34 and a PV recycle stream 36 (e.g., including ions such as Ca²⁺, Mg²⁺, and SO₄²⁻. The recycle seawater system 30 may generate the recycle seawater stream 32 that includes an amount of MV ions from the MV recycle stream 34 and/or PV ions from the PV recycle stream 36. Additional features of the recycle seawater blending and storage system are discussed with respect to FIG. 2. In some embodiments, the recycle seawater system 30 may enable startup of the desalination system with an increased seawater flow until the recycle seawater system may generate the recycle seawater stream 32 by providing the recycle seawater stream 32 to the NF System 20. That is, the recycle seawater system 30 may store a volume of fluid based on the pretreated backwash stream 28 and MV and/or PV ions may be added to the recycle seawater system 30 to adjust the concentration of ions in the recycle seawater stream 32.

In some embodiments, a flow controller may adjust the flow of the recycle seawater stream 32 from the recycle seawater system 30 to the NF system during certain conditions, such as a time period corresponding to startup when recycle flows are not yet available. For example, as the recycle seawater stream 32 is established (i.e., being produced) the fresh seawater flow (e.g., the pretreated feed stream 18 generated from the feed stream 14) is reduced to maintain a constant flow of seawater to the NF system 20. It should be noted that it may be desirable to provide an NF system (e.g., one or more NF units of an NF system) with an amount of water above a threshold to improve the effectiveness of the NF unit. Accordingly, a fresh seawater flow provided to the NF system may be adjusted (e.g., via a flow controller adjusting one or more flow control devices) to compensate for the variable recycle seawater stream 32 and to maintain a constant seawater flow to the NF system. As used herein, “upsets” may include gypsum slurry piping plugging and unplugging activity, which may cause the recycle flow to temporarily decrease and then increase. The pretreatment backflush and spent membrane cleaning solutions may be treated and included in the recycle seawater system, as discussed in more detail with respect to FIG. 2.

As illustrated, the desalination system 10 includes an RO system 38 that receives the MV brine stream 22 and produces a desalinated water stream 40 and a RO concentrate stream 42. In some embodiments, the RO system 38 may provide the RO concentrate stream 42 to an RO tank 44. In any case, the RO system 38 may provide an RO concentrate stream 46 (i.e., RO concentrate stored in the RO tank 44) to an evaporator section 48 (e.g., MV brine evaporator). In general, the evaporator section 46 may remove water (e.g., the condensate 50) from the RO concentrate stream 42, thereby producing a first MV concentrate stream 52. As illustrated, the condensate 50 may be extracted as desalination water 40. In certain embodiments, the evaporator section 48 includes a mechanical vapor recompression (MVR) evaporator system. In certain embodiments, the evaporator section 48 includes a vacuum evaporator. In certain embodiments, the first MV concentrate stream 52 may be stored in a MV concentrate tank 54. In any case, the evaporator section 48 may provide the MV concentrate 56 (e.g., including the first MV concentrate stream 52 and/or the MV concentrate stored in the MV concentrate tank 54) to a MV mineral recovery unit 58. The MV mineral recovery unit 58 may remove residual amounts of polyvalent minerals from the MV concentrate, thereby producing polyvalent streams, such as a magnesium hydroxide (Mg(OH)₂) stream 60 and a calcium carbonate (CaCO₃) 62, and a monovalent mineral stream 64.

As illustrated, the desalination system 10 includes a gypsum recovery system 66 that receives the PV brine stream 24 and recovers the Ca and SO₄ from the PV brine stream 24 to generate gypsum 68 and a gypsum slurry stream 70. The gypsum recovery system 66 may receive a calcium brine stream 71 as a calcium source to generate the gypsum 68. In certain embodiments, the gypsum slurry stream 70 may be stored in a tank 73 for further use. In certain embodiments, the gypsum recovery system 66 may include a reactor, a settler, and a filter, as described in further detail herein. Furthermore, the gypsum recovery system 66 may generate the PV recycle stream 36 and direct the PV recycle stream 36 to the recycle seawater system 30. Furthermore, the gypsum recovery system 66 may generate a gypsum slurry stream 72 and direct the gypsum slurry stream 72 to a second evaporator section 74. In certain embodiments, the second evaporator section 74 includes a mechanical vapor recompression (MVR) evaporator system. In certain embodiments, the second evaporator section 74 includes a vacuum evaporator. In any case, the second evaporator section 74 removes water (e.g., a condensate stream 76) from the gypsum slurry stream 72, thereby producing a gypsum slurry concentrate stream 78, and the second evaporator section 74 directs the gypsum slurry concentrate stream 78 to a crystallizer section 80. In certain embodiments, the crystallizer section 80 may include a heat pump or multieffect crystallizer and/or a filter. In certain embodiments, the crystallizer section 80 receives a calcium chloride (CaCl₂)) stream 82, which mixes with the gypsum slurry concentrate stream 66 thereby removing residual ions, such as sulfate. Furthermore, the crystallizer section 80 may remove water (e.g., a condensate stream 84) from the gypsum slurry concentrate stream 78, thereby producing a recycle gypsum slurry filtrate stream 86. The gypsum recovery system 66 receives the recycle gypsum slurry filtrate stream 86 and recovers the Ca and SO₄, thereby generating additional gypsum 68.

As illustrated, the desalination system 10 includes a magnesium recovery system 88 that generally removes and/or further purifies magnesium from magnesium-containing streams. For example, as shown in the illustrated embodiment, the magnesium recovery unit may receive the Mg(OH)₂ stream 60 and the gypsum slurry stream 70 (e.g., via the tank 73). In general, the Mg(OH)₂ stream 60 and the gypsum slurry stream 70 may include certain polyatomic species, such as CaCl₂), and monovalent species. Accordingly, the magnesium recovery system 88 may extract a CaCl₂) brine stream 90. In some embodiments, the CaCl₂) brine stream 90 may be stored in a tank 92 and/or provided to the crystallizer section 80 and/or gypsum recovery section 66. Further still, the magnesium recovery system 88 may remove the monovalent ions from the streams provided to the magnesium recovery system 88, thereby generating a concentrated monovalent brine 94 and/or a dilute monovalent brine 96. As illustrated, the magnesium recovery system 88 directs the concentrated monovalent brine 94 to the tank 44, and ultimately, provides MV brine streams (e.g., generated by the evaporator section 48 using the concentrated monovalent brine 94 and/or provided directly by the dilute monovalent brine 96) to the MV minerals recovery unit 58 to produce additional monovalent minerals 64 and/or the MV recycle stream concentrate 34. In certain embodiments, the magnesium recovery system 88 may receive a lime/dolime supply 98. In any case, by removing the MV species (e.g., via the concentrated monovalent brine 94 and/or the dilute monovalent brine 96) and the PV species (e.g., the CaCl₂) brine stream 90), the magnesium recovery system 88 generates a MgCl₂ brine stream 100 and/or magnesium oxide (MgO) 102. At least in some instances, the MgCl₂ brine stream 100 may be stored in a brine tank 104, where it may ultimately be further purified to produce Mg metal 106 and HCl 108.

In some embodiments, one or more tanks may be included between the NF systems, the Reverse Osmosis (RO) systems, and the mineral recovery systems (e.g., monovalent mineral recovery, magnesium recovery, gypsum recovery, and the like) to separate the continuously or semi-continuously operating NF, RO, and gypsum system from the high value minerals recovery systems. That is, it may be advantageous to run certain systems, such as the NF system and the RO system, continuously, while running other systems periodically. For example, operating the NF and RO membranes continuously in a narrow range of flow and composition conditions may increase membrane life. As another example, operating the gypsum system continuously may reduce scaling from the divalent brine due to gypsum until the gypsum is fully precipitated and filtered from the PV brine. The tanks may also provide feedstock security for the downstream minerals recovery plants to ensure that water plant upsets do not cause downstream minerals recovery plant upsets.

In some embodiments, large tanks or ponds may be used to store the high volume (e.g., approximately 30-40% of feed seawater) RO concentrate stream (MV brine). This enables the large MV brine evaporator to have a flexible energy consumption to match available renewable power or CSP cogen steam.

### Recycle Seawater System

FIG. 2 is a block diagram of an embodiment of a recycle seawater system 30 fluidly coupled to the pretreatment system 12. In the illustrated embodiment, the recycle seawater system 30 includes a solids filtration unit 110, a first recycle seawater tank 112, and a second recycle seawater tank 114 that generate the recycle seawater stream 32 that is provided to a water processing system 109 (e.g., one or more components of the desalination system 10 including the NF system). In general, the pretreatment system 12 receives the feed stream 14 and generates the pretreated feed stream 18. The desalination system 109 receives the pretreated feed stream 18, the recycle seawater stream 32, or a combination of both. For example, as described herein, the recycle seawater stream 32 may be used to supplement the volume of the pretreated feed stream 18 until the volume of the pretreated feed stream 18 exceeds a threshold (e.g., a flow rate threshold, a flow amount threshold, volumetric flow threshold), thereby providing the NF system with an amount of water above a threshold and supplementing the pretreated feed stream 18 and/or modifying the flow of the feed stream 14 (e.g., which modifies the flow of the pretreated stream 18).

In certain embodiments, the volumetric flow rate of the feed stream 14 provided to the pretreatment system 12 may be greater than 900,000 cubic meters per day (m³/d), greater than 1,000,000 m³/d, greater than 1,100,000 m³/d, or greater than 1,200,000 m³/d. In certain embodiments, the volumetric flow rate of the pretreated feed stream 18 provided to the desalination system 109 (e.g., the NF system 20 as described with respect to FIG. 1) may be greater than 900,000 cubic meters per day (m³/d), greater than 1,000,000 m³/d, greater than 1,100,000 m³/d, or greater than 1,200,000 m³/d. In certain embodiments, the concentration of a pretreated filtrate stream 120 from the solids filter 110 may be greater than 30,000 milligrams per liter (mg/l), greater than 35,000 mg/l, greater than 40,000 mg/l, or greater than 47,000 m³/d. The volumetric flow rate of the recycle seawater stream 32 is generally selected to supplement the volumetric flow rate of the pretreated feed stream 18, which is provided to the NF system. That is, it may be desirable to provide a first volumetric flow rate of the pretreated feed stream 18 and a second volumetric flow rate of the recycle seawater stream 32 to the NF system 20, such that the sum of the first volumetric flow rate and the second volumetric flow rate are approximately equal to a volumetric flow rate threshold. In certain embodiments, the volumetric flow rate threshold volume may be approximately 1,000,000 m³/d, 1,050,000 m³/d, or 1,090,000 m³/d. For example, if the volumetric flow rate threshold volume is 1,000,000 m³/d and 800,000 m³/d of the pretreated feed stream 18 is provided to the NF system 20, then 200,000 m³/d of the recycle seawater stream 32 may be provided to the NF system 20.

As illustrated, the solids filtration unit 110 of the recycle seawater system 30 receives the pretreated backwash stream 28. The solids filtration unit 110 may filter out solid materials, such as biosolids 118, from the pretreated backwash stream 28, thereby generating a pretreated filtrate stream 120. In certain embodiments, the volumetric flow rate of pretreated filtrate stream 120 provided to the first recycle seawater tank 112 may be greater than 50,000 cubic meters per day (m³/d), greater than 55,000 m³/d, greater than 65,000 m³/d, or greater than 70,000 m³/d. In certain embodiments, the concentration of the pretreated filtrate stream 120 may be greater than 30,000 milligrams per liter (mg/l), greater than 35,000 mg/l, greater than 40,000 mg/l, or greater than 47,000 m³/l.

As illustrated, the first recycle seawater tank 112 receives the pretreated filtrate 120. In general, multiple recycle, startup, intermittent backwash, and upset streams may be generated by the full recovery desalination system 10. For example, as shown in the illustrated embodiment, the first recycle seawater tank 112 receives a MV NF concentrate stream 34, a PV NF permeate stream 122 (e.g., the PV recycle stream 36), a SWRO concentrate stream 124, a SWNF permeate stream 126, and a SWNF concentrate stream 128. In certain embodiments, the volumetric flow rate of the MV NF concentrate stream 34 provided to the first recycle seawater tank 112 may be greater than 1000 cubic meters per day (m³/d), greater than 1200 m³/d, greater than 1400 m³/d, or greater than 1600 m³/d. In certain embodiments, the concentration of the MV NF concentrate stream 34 may be greater than 100,000 milligrams per liter (mg/l), greater than 200,000 mg/l, greater than 300,000 mg/l, or greater than 400,000 m³/l. In certain embodiments, the volumetric flow rate of the PV NF permeate stream 122 provided to the first recycle seawater tank 112 may be greater than 50,000 cubic meters per day (m³/d), greater than 55,000 m³/d, greater than 65,000 m³/d, or greater than 69,000 m³/d. In certain embodiments, the concentration of the PV NF permeate stream 122 may be greater than 30,000 milligrams per liter (mg/l), greater than 35,000 mg/l, greater than 40,000 mg/l, or greater than 41,000 m³/l. In some embodiments, the first recycle seawater tank 112 may receive the SWRO concentrate stream 124 during start up and/or upsets (e.g., only during start up and/or upsets). In some embodiments, the first recycle seawater tank 114 may receive the SWNF permeate stream 126 during start up (e.g., only during startup). In some embodiments, the first recycle seawater tank 112 may receive the SWNF concentrate stream 128 during startup (e.g., while or only while the volumetric flow rate of the pretreated feed stream 18 to the NF system is below a threshold) and/or during upsets (e.g., only during startup and/or upsets).

One or more of these streams may be blended together in an initial proof tank (e.g., first recycle seawater tank 112) along with desalinated water 40, at least in some instances, to decrease the concentration of ions ultimately present in the recycle seawater stream 32. In some embodiments, the flow of the MV NF concentrate stream 34 may be increased and/or the seawater RO (SWRO) concentrate stream 124 and/or the seawater NF (SWNF) concentrate stream 128 may be added to increase the salinity, calcium content, magnesium content, sulfate content, or a combination thereof, of the recycle seawater stream 32.

At least in some instances, if the proof tank contents have been blended to a target concentration (e.g., 47,000 mg/l) within the acceptable range of seawater, the solution within the first recycle seawater tank 112 may be transferred to the run tank (e.g., the second recycle seawater tank 114) where it may be continuously or periodically (e.g., hourly, twice an hour, daily, weekly, etc.) fed to the desalination system 10 (e.g., upstream of the NF system 20). The fresh seawater flow 14 and/or the recycle seawater flow 32 may be adjusted to maintain a constant total seawater flow within the desalination system 10. In certain embodiments, as illustrated, the volumetric flow rate of the fresh seawater flow 14 and/or the recycle seawater flow 32 may be adjust by a flow controller 113. In general, the flow controller 113 may include a memory 115 and a processor 117. Programs or instructions executed by the processor 12 may be stored in any suitable article of manufacture that includes one or more tangible, computer-readable media, such as the memory 115. In some embodiments, the processor 117 of the flow controller 113 may be capable of outputting a control signal that causes one of the flow control devices 119 (e.g., valves) to actuate, thereby modifying the flow of the feed stream 14 and/or the flow rate of the recycle seawater flow 32 to the NF system 20. For example, the processor 117 may cause the valve 119a to open and/or close the valve 119b when the volumetric flow rate of the feed stream 14 is above a volumetric flow threshold, thereby increasing the volumetric flow rate of the feed stream 14 and decreasing the flow rate of the volumetric flow rate of the recycle seawater flow 32 to the water processing system 95. The tanks and recycle streams may have a sufficient volume to reduce an amount of discharge back to the ocean. In any case, minerals from the pretreated seawater and/or the recycle seawater stream 32 may be extracted to produce desalinated water 40, the PV NF permeate stream 122 and the MV NF concentrate stream 34 (e.g. which may be directed back to the first recycle seawater tank 92), and/or other fluid products 125 (e.g., CO₂ and other gaseous products).

### NF Permeate Recycle and SWRO System

As described above, the pretreated stream 18 and/or the recycle seawater stream 32 may be directed to the NF system 20. To illustrate this, FIG. 3 is a block diagram of an embodiment of the NF system 20, having a first NF unit 136 and a second NF unit 146, that generates a NF permeate recycle stream 32 based on the pretreated stream 18.

As illustrated, an NF feed tank 130 receives the pretreated seawater stream 18. In certain embodiments, H₂SO₄ 132 and/or NaOH 134 may be added to the pretreated seawater stream 18 to adjust (e.g., increase or decrease) the pH to be within a pH threshold range (e.g., between 4.0-6.0, between 4.5-5.5, between 4.9-5.1, or approximately 5.0). It should be noted that adjusting the pH of the pretreated seawater stream 18 may prevent or reduce carbonate scaling on the units of the NF system 20. Furthermore, the H₂SO₄ 132 may adjust the sulfate content. The first NF unit 136 receives a pretreated seawater stream 138 (e.g., pretreated seawater stream 18 with the adjusted pH) from the NF feed tank 130 (e.g., via a pump 140). The first NF unit 136 filters out at least a first portion of the elements and/or compounds present in the pretreated seawater stream 138, thereby producing a first NF permeate 142 and a first NF filtrate 144. Furthermore, the second NF unit 146 receives the first NF filtrate 144 (e.g., via a pump 140). The second NF unit 146 filters out at least a second portion of the elements and/or compounds present in the first NF filtrate 144, thereby producing an NF recycle stream 26 or NF permeate recycle stream (e.g., the permeate of the second NF unit 146) and a second NF filtrate 150. In certain embodiments, the second NF filtrate 150 may be combined with the PV brine stream 24 and directed to the gypsum recovery system 66. In any case, the first NF feed tank 130 receives the permeate recycle stream 26 to further separate compounds with MV ions from compounds with PV ions.

As described above, the H₂SO₄ 132 may be added to adjust the sulfate content of the pretreated stream 18. In certain embodiments, the sulfate content may be adjusted to simultaneously meet NF recovery targets and NF calcium and magnesium rejection targets. It may be desirable to provide a low cost onsite produced sulfuric acid and lower cost dilute (e.g., approximately 5-30 wt %) onsite produced NaOH instead of purchasing sodium sulfate since both chemicals are liquids and may be used extensively throughout the desalination system. This may also provide a benefit of avoiding installation of a separate receiving, solid storage, and mixing system for sodium sulfate.

In certain embodiments, the first NF unit 136 and the second NF unit 146 may have different filtration capabilities. For example, the first NF unit 136 may be a tight NF unit, and the second NF unit 146 may be a loose NF unit. As referred to herein, a “loose” NF unit may enable a relatively larger amount of certain ions (e.g., divalent ions) to permeate through the loose NF unit as compared to the “tight” NF unit. The lower quality NF permeate (e.g., containing a higher percentage of certain ions) from the second (e.g., the second NF unit) and/or third stages (e.g., additional NF units arranged in a generally similar manner as described with respect to the first NF unit 136 and the second NF unit 146) is recycled (e.g., via the NF permeate recycle stream 26) to enhance (e.g., maximize) calcium, magnesium, and sulfate rejection. Loose NF membranes may be advantageous for the recycle stages since these maximize overall recovery and produce a permeate stream that is higher in sulfate which is preferable for recycle permeate since it increases rejection in the tight NF initial stages. In this way, an arrangement of NF units having different filtrate capabilities may reduce slip of PV ions into the NF permeate stream (e.g., the MV brine stream 22), reduce an amount of MV ions (e.g., sodium content) in the NF concentrate stream 24, reduce the flow of the NF concentrate stream 24, or a combination thereof.

In some embodiments, a degasifier 151 may be positioned downstream of the first NF unit 136 and receive the first NF permeate 142. The degasifier 151 may be used to raise the pH of the stream flowing to the SWRO (e.g., the RO system 38) in embodiments in which an increased pH improves SWRO performance. In general, the degasifier 151 may remove CO₂ 152 and/or air 153 from the first NF permeate 142, thereby generating the NF permeate stream 22, which may be degassed in such embodiments. In other embodiments, the CO₂ 152 may be routed to the desalinated water (e.g., in the SWRO permeate and evaporator condensate) where the desalinated water may be converted to beneficial alkalinity (e.g., to produce desalinated water 40 that is less corrosive or substantially non-corrosive) during downstream remineralization with calcium carbonate generated by the desalination system 10. In embodiments in which the degasifier 151 is used, the air and CO₂ from the scrubber may be routed to a downstream scrubber for recovery and use in remineralizing the desalinated water.

### SWRO Concentrate Brine Concentrator—MED

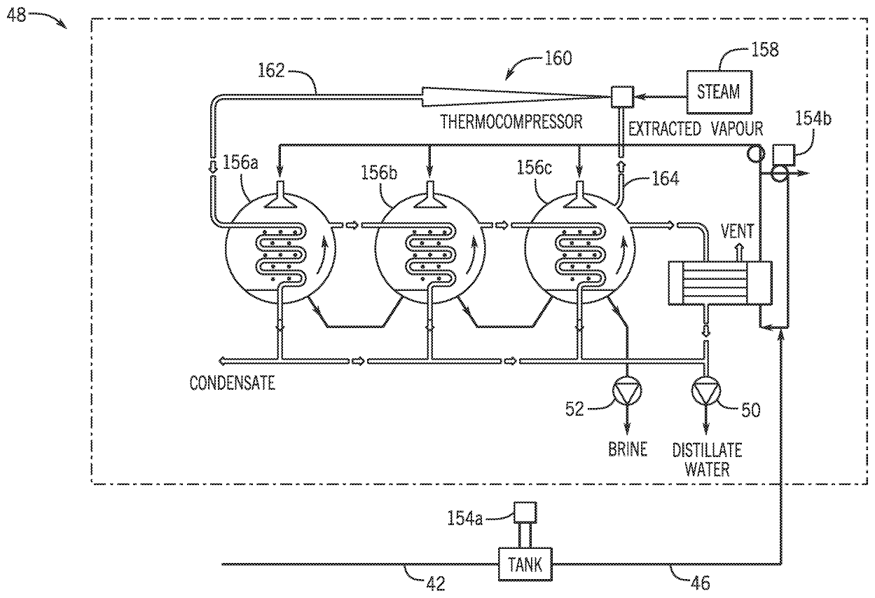

As described above with respect to FIG. 1, the RO system 38 may generate the RO concentrate stream 42 and/or the RO concentrate stream 46. FIG. 4 is a block diagram of an embodiment of the evaporator section 48 In general, the SWRO Concentrate Brine Concentrator 152 receives the RO concentrate stream 46 (e.g., which may include the RO concentrate stream 42 stored in the tank 44). As illustrated, the evaporator section 48 includes heat pumps 154 and condensers 156. As shown in the illustrated embodiment, the tank 44 is thermally coupled to a first heat pump 154a and the evaporator section 48 includes a second heat pump 154b. The heat pumps 154 adjust the temperature of the RO condensate stream 46. For example, the second heat pump 154b may increase the temperature of the RO condensate stream 46 from 23° C. to 40° C. The heated RO condensate stream 46 may then be directed to one or more of the condensers 156. In some embodiments, each of the condensers 156 may receive a flow of steam 158, which is subsequently expanded in a thermal compressor 160, and thus forming a liquid 162 (e.g. water) having a relatively lower temperature. For example, the temperature of the liquid 162 and the first condenser 156a may be approximately 130° C., the temperature of the liquid 162 in the second condenser 156b may be approximately 50° C., and the temperature of the liquid 162 in the third condenser 156c may be approximately 30° C. In any case, water may be removed from the RO concentrate stream 46 and/or the RO concentrate stream 42 via evaporation and directed along the conduit 164 (e.g., producing steam 158), thus generating RO condensate 50 (e.g., condensing the vapor in the condensers 156) and the first MV concentrate stream 52.

In some embodiments, the evaporator section 48 may include a steam powered multieffect distillation (MED) brine concentrator and/or an electrically powered mechanical vapor recompression (MVR) brine concentrator to further concentrate the SWRO concentrate. The MED unit may be equipped with a feed chiller (e.g., a heat pump 154a) which cools the feed and substantially maintains a constant year round feed temperature. During time periods of relatively low temperature (e.g., winter) conditions, the renewable power may be redirected to the supplemental electric heater on the CSP cogen to help make up for an amount of solar energy used to power the evaporator section falling below a threshold, such as during the winter, thereby enabling year round baseload steam and power generation.

The second heat pump 154b may be used to chill a portion of the condenser effluent, thereby enabling recycle and no discharge. As such, a relatively large portion (e.g., greater than 80%, greater than 90%, greater than 95%, greater than 98%, or greater than 99%) of the condenser heat to be used for desalination may preheat the RO concentrate stream 46. The top brine temperature may be increased to 130° C. since the feed is the MV brine stream 22, which is not prone to scaling (e.g., due to the calcium removed at the NF system 20). The increased top brine temperature and the lower feed temperature (e.g., lower brine temperature) may enable a higher number of stages, which enables the MED to achieve a gain output ratio (GOR), such as a ratio of product desalinated water to feed steam, of approximately 15-20, thereby reducing steam consumption and cost of operation. Thermal vapor recompression (e.g., a steam eductor) may be used with the CSP cogen steam (e.g., approximately 4 bar) to further increase efficiency by recycling a portion of the lower pressure steam produced within the MED.

The higher feed salinity (e.g., approximately 10 wt % total dissolved solids (TDS) versus 4.7 wt % TDS seawater) may decrease MED efficiency due to increased boiling point elevation. However, the MED may be piloted using 7 wt % TDS feed, which may result in a relatively lower cost desalinated water production at a 55-60% recovery.

### SWRO Concentrate Brine Concentrator—MVR

A standard electrically powered MVR brine concentrator may be alternatively used to concentrate the SWRO concentrate (e.g., generating the first MV brine concentrate stream). It may be desirable to implement such an embodiment in certain instances, such as when low cost baseload green power is available. The non-scaling feed brine (e.g., the RO concentrate stream 42 and/or the RO concentrate stream 46 having calcium removed by the NF system 20) may enhance the efficiency of the MVR. Multiple MVR units are used in series to reduce boiling point rise and to reduce utilized compressor discharge pressure while evaporating the brine.

### SWRO Concentrate Pretreatment and Crystallization

In some embodiments, first MV concentrate stream 52 from the evaporator section 48 is further concentrated in an MVR to achieve 20-24 wt % NaCl content (e.g., approximately 80-90% saturated). Heat recovery may be used on both brine and condensate to reduce supplemental LP steam utilized.

In any case, the cooled first MV concentrate stream 52 may be routed to boric acid ion exchange. This resin is formulated to remove boric acid from brines, especially high magnesium content brines used for magnesium metal and magnesium hydroxide/oxide production. Controlling the pH between 6-8 may substantially reduce or prevent magnesium hydroxide precipitation while still providing sufficient boric acid removal. In general, a boric acid removal system may include a boric acid ion exchange resin that receives a boron rich stream and generates a boric acid rich brine. The boric acid rich brine from a boric acid removal system may be routed to a boric acid recovery system. In some embodiments, the boron-containing brine may include one or more of the streams 42, 47, 72, and 78. Additionally or alternatively, the gypsum filtrate stream 72 may be routed to a boric acid recovery system.

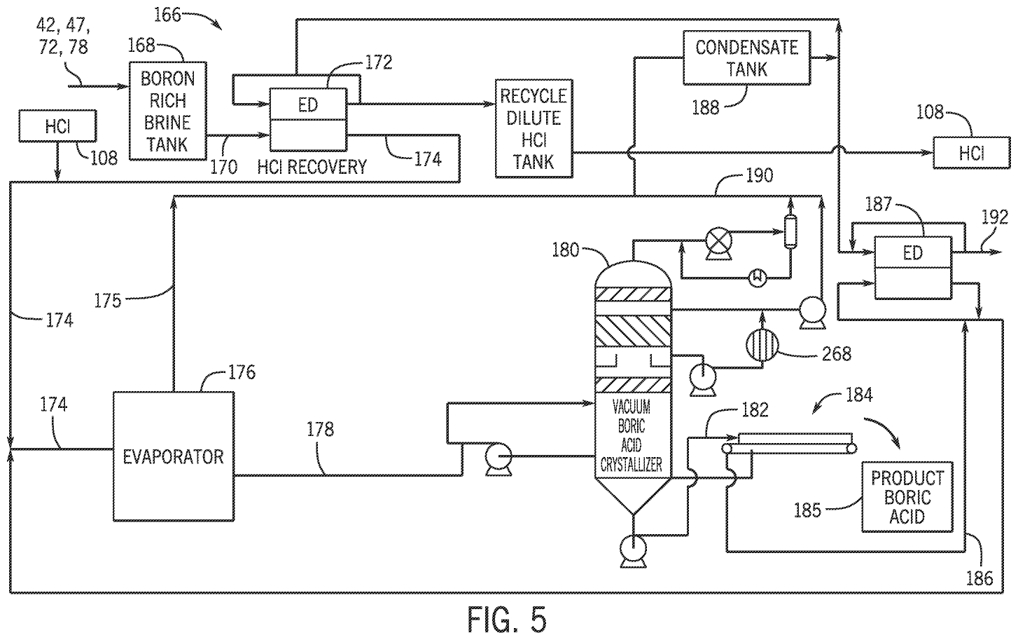

FIG. 5 is a block diagram of an embodiment of a boric acid recovery system 166 that may be employed within the desalination system 10 of FIG. 1, in which the boric acid recovery system 166 is configured to produce boric acid, NaCl, KCl, trace salts, and water using MV containing streams such as the streams 42, 47, 72, and 78. In the illustrated embodiment, one or more of the streams 42, 47, 72, and 78 are stored in a boric acid concentrate tank 168. For simplicity, each of the streams may be referred to as a boric acid concentrate solution 170. The boric acid concentrate solution 170 is directed to an electrodialysis (ED) unit 172 that extracts HCl 108 from the boric acid concentrate solution 170 to generate a slow acid containing (e.g., less than approximately 0.2 wt % HCl) boric acid stream 174. The slow boric acid stream 174 may be directed to one or more heat exchangers, and ultimately is fed from the heat exchangers to an evaporator 176, which removes water (e.g., vapor stream 175) from the slow boric acid stream 174 to generate a concentrated boric acid stream 178. For example, the evaporator 176 may operate under 12 pound per square inch absolute (psia) at approximately 210 F. The concentrated boric acid stream 178 may include approximately 20 wt % of boric acid and NaCl (e.g., 30,000 mg/l). The concentrated boric acid stream 178 is directed to a vacuum crystallizer 180 that removes more of the water from the concentrated boric acid stream 178. For example, the vacuum crystallizer 180 may operate under 1 pound per square inch absolute (psia) at approximately 45° C. The resulting boric acid product 182 is then routed to a vacuum belt filter 184, where the boric acid product 182 is washed to remove residual acid and/or trace salts (e.g., NaCl and KCl present in a brine stream 186) and is heated to remove water to produce boric acid 185. In the illustrated embodiment, the boric acid recovery system 166 also includes a second ED 187 configured to recycle any trace salts. For example, the second ED 187 may receive a condensate from a condensate tank 188 and/or a vapor streams 175, 190 to produce a purge brine solution 192 that includes approximately 4 wt % NaCl and/or less than approximately 100 mg/L of boric acid.

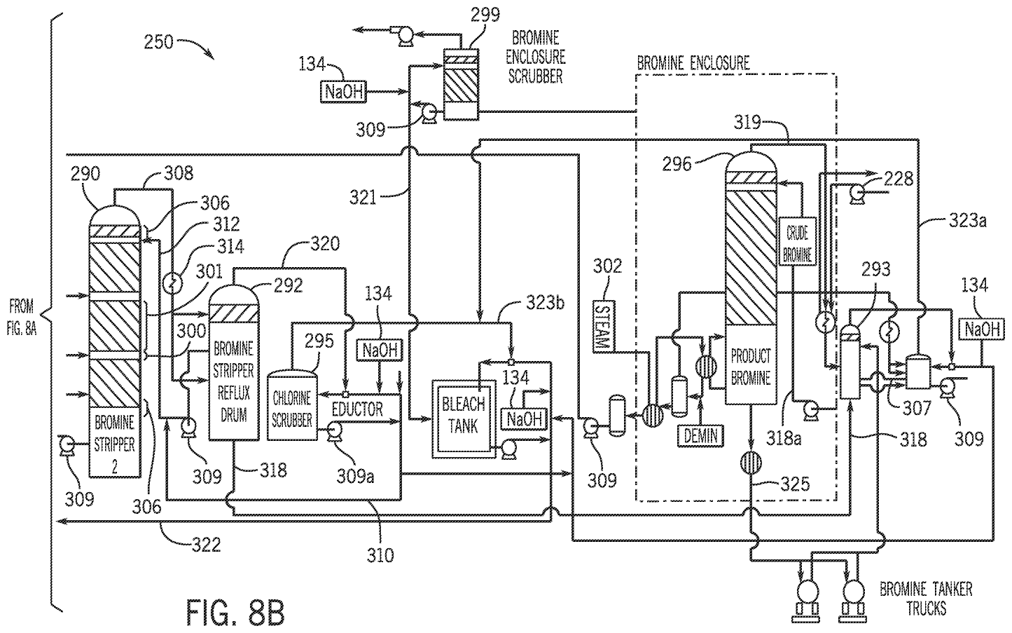

The softened, low boron sodium chloride brine (e.g., the purge brine solution 192) may be routed to an MVR crystallizer to produce high purity, low bromide chemical grade salt and desalinated water. The tail brine from the MVR crystallizer (e.g, as discussed in more detail with respect to the stream 352 of FIG. 9) may be routed to a vacuum crystallizer to produce fertilizer grade potassium chloride and desalinated water. The tail brine from the vacuum crystallizer may be routed to a second MVR crystallizer that produces desalinated water and a low purity mixed salt that is recycled back to a sodium chloride storage where it may be redissolved.

In some embodiments, the small tail brine flow (e.g., <50 GPM) from a mixed salt MVR crystallizer, (e.g., tail brine stream 352 as described with respect to FIG. 9) is routed to a tail brine storage unit, which may enhance system reliability. The tail brine from the tail brine storage may be routed to a fluid bed calcium fluoride removal unit where self-generated calcium chloride brine is mixed with the tail brine to produce calcium fluoride and a treated tail brine. The treated tail brine is then routed to a bromine recovery unit which uses chlorine and steam in a distillation process to extract bromine from the treated tail brine. The bromine is then dried in a sulfuric acid drying system to produce product bromine.

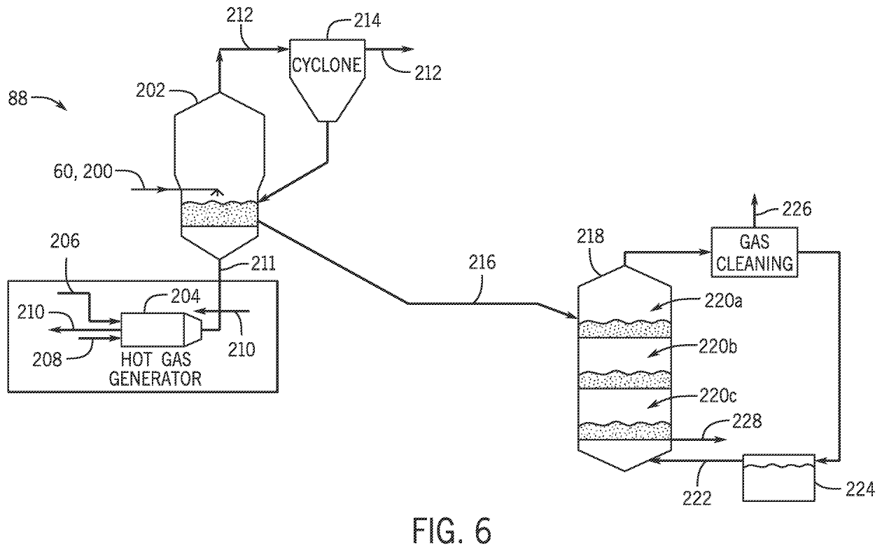

After boric acid removal, the brine may be reheated using a heat pump and a feed product exchanger to approximately 70° C. to facilitate magnesium and calcium removal. A reactor, settler, filter system may be used to precipitate magnesium down to 50-100 mg/l (e.g., approximately 80-90% removal). The upstream boric acid removal and the reduced magnesium removal may enable the magnesium reactor to operate at a pH less than 10.5 and have a 30-60 minute residence time. This combination may produce relatively larger crystals, and thus improve settling (e.g., approximately 15-25 wt % settler bottoms) and filtering (e.g., greater than approximately 50 wt % solids filter cake). Without upstream boric acid removal, the magnesium hydroxide may have small non-settleable and non-filterable crystals (i.e., which occurs due to a relatively short (e.g., less than 10 minute) residence time within the reactor) or would have boric acid adsorption onto the magnesium hydroxide (i.e., which occurs due to a relatively long (e.g., greater than 10 minute) residence time within the reactor). The magnesium hydroxide purity is very high (e.g., greater than approximately 99%) since there may only be silica coprecipitation (i.e., no calcium carbonate coprecipitation or boron contamination). The magnesium hydroxide may be filtered and dried, as described in more detail with respect to FIG. 6, and may be either sold as a high purity product or may be routed to the electrically heated calciner.

FIG. 6 is a schematic diagram a first example of the magnesium chloride recovery system 88 that may be included in the desalination system 10. In general, the magnesium recovery system 88 of FIG. 6 may receive the Mg(OH)₂ stream 60 and/or a tail brine stream 200 that contains magnesium ions. For example, the Mg(OH)₂ stream 60 and/or the tail brine stream 200 may include approximately 45 wt % MgCl₂. The Mg(OH)₂ stream 60 and/or the tail brine stream 200 may be heated to approximately 120° C. via a low pressure steam (LP steam). Next, the Mg(OH)₂ stream 60 and/or the tail brine stream 200 (e.g., the magnesium brine feed stream) may be heated to approximately 180° C. in a first reactor vessel 202 using a hot gas generator 204. For example, the hot gas generator 204 may receive a natural gas stream 206 and air stream 208, which are combusted in the hot gas generator 204 via a molten salt 210 to generate a heated airflow 212. For example, the molten salt 210 may be approximately 500° C., which may produce the heated airflow 211 having a temperature of approximately 350° C. The heated reactor vessel 202 may generate a degas stream 212, including water and other volatile products (e.g., HCl and/or O₂) that are removed from the Mg(OH)₂ stream 60 and/or the tail brine stream 200. This process (e.g., directed the stream through the first reactor vessel 212 and/or the second reactor vessel 218) may be repeated via mixing of the solid products in the cyclone 214 to produce a magnesium chloride hydrate product 216 (e.g., approximately 97 wt % MgCl₂ 6H₂O, approximately 3% MgOHCl). At least in some embodiments, the hot gas generator 204 may include a CSP molten salt heat exchanger that creates a heated airflow for heating the stream in the second reactor vessel 218.

As illustrated, the magnesium chloride hydrate product 216 is directed to a second reaction vessel 218. As illustrated, in certain embodiments, the second reactor vessel 218 may be a multistage reaction vessel (e.g., having stages 220a, 220b, 220c) For example, each stage 220a, 220b, 220c may be heated to a different temperature. For example, the first stage 220a may be heated to 180° C., the second stage 220b may be heated to 250° C., and the third stage 220c may be heated to greater than 300° C. The second reactor vessel 218 may receive a hot HCl fluid flow 222 that is heated by a CSP molten salt heat exchanger 224. Water may be removed from the magnesium chloride hydrate product 216, thereby generating a water stream 226 and a magnesium chloride product 228, thereby recovering a substantial portion (e.g., greater than 90%, greater than 95%, greater than 99%, etc.) of the magnesium in the feed stream 14.

After boric acid removal (e.g., and bulk magnesium removal), sodium carbonate is added to the brine in a microfiltration (back pulse filter) based softener system. In some embodiments, the sodium carbonate may be produced from an onsite caustic scrubber of the various CO₂ containing air streams (SWRO degasifier offgas, gypsum reactor offgas, MED/MVR non-condensible vent gas). Sodium hydroxide may be added to increase the pH to greater than 11. Increasing the pH may cause precipitation of essentially all the calcium, magnesium (e.g., less than 1 mg/l Ca, less than 0.1 mg/l Mg), and nearly all the silica (e.g., less than 5 mg/l SiO₂). The upstream removal of the bulk of the magnesium may enable a high calcium to magnesium ratio in the feed brine, which may increase flux through the filter and reduce filter area requirements.

After boric acid, magnesium, silica, and calcium removal, the MV brine streams (e.g., the concentrated monovalent brine 94 and/or a dilute monovalent brine 96) may be routed to an NF unit to remove the residual sulfate and trace amounts of magnesium and calcium. The NF concentrate is routed to the MV tail brine system, which is discussed in more detail in FIG. 9. The NF permeate is routed to a mix tank where recycle salt from the MV tail brine system is added to the brine to increase its NaCl concentration to near saturation.

The near saturated MV brine is routed to either an electrically powered MVR crystallizer or a steam powered multi-effect crystallizer. The multiple (e.g., 2, 3, 4, 5, 6, 7, or more than 7) MVR crystallizers may be arranged in series, and the multi-effect crystallizer may have 5 stages. The salt recovery may be limited to 75-80% per pass to reduce bromide content (e.g., less than 100 mg/l) in the NaCl salt product. The highly purified brine may also limit calcium to less than 2 mg/l, magnesium to less than 2 mg/l and sulfate to less than 1 mg/l. This significantly increases the market value of the salt for the chlor-alkali market since no waste solids or brine will be produced.

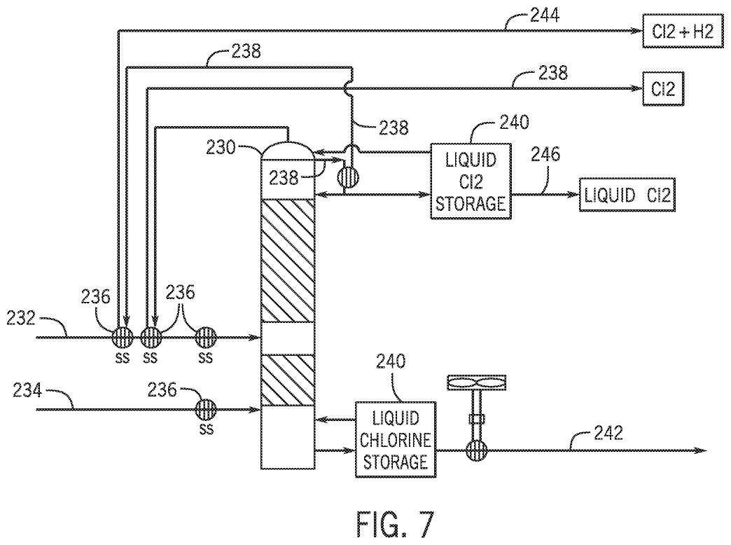

If an onsite chlor-alkali plant is used to convert the salt to chlorine, hydrogen, and sodium hydroxide, then the bromine may be removed in a chlorine scrubber. An example of such a chlorine scrubber is shown in FIG. 7. As shown in FIG. 7, the chlorine scrubber 230 generally receives a first chlorine stream 232 and/or a second chlorine stream 234. The first chlorine stream 232 may include a relatively high percentage of chlorine (e.g., greater than 50%, greater than 60%, greater than 80%, greater than 90%, or approximately 97%), while the second chlorine stream 234 may include a relatively low percentage of chlorine (e.g., less than 50%, less than 40%, less than 30%, less than 20%, or less than 10%). The first chlorine stream 232 may be cooled to a first temperature (e.g., 0° C.) via heat exchangers 236, and the second chlorine stream 234 may be cooled to a second temperature, greater than the first temperature, such as 15° C. The resultant chlorine product stream 238 from the chlorine scrubber 230 may be recirculated through the heat exchangers 236 to assist with cooling the first chlorine stream 232. In any case, the chlorine product stream 238 may be stored in a chlorine storage tank 240 and distributed to other components of the desalination system 10. For example, the chlorine product stream 238 may be separated to generate a bromine containing chlorine product stream 242 that may be further purified (e.g., by extracting the bromine). The chlorine product stream 238 may also be separated to generate a chlorine and hydrogen product stream 244, and/or the chlorine product stream may be stored as liquid chlorine 246 (e.g., the chlorine storage tank 240).

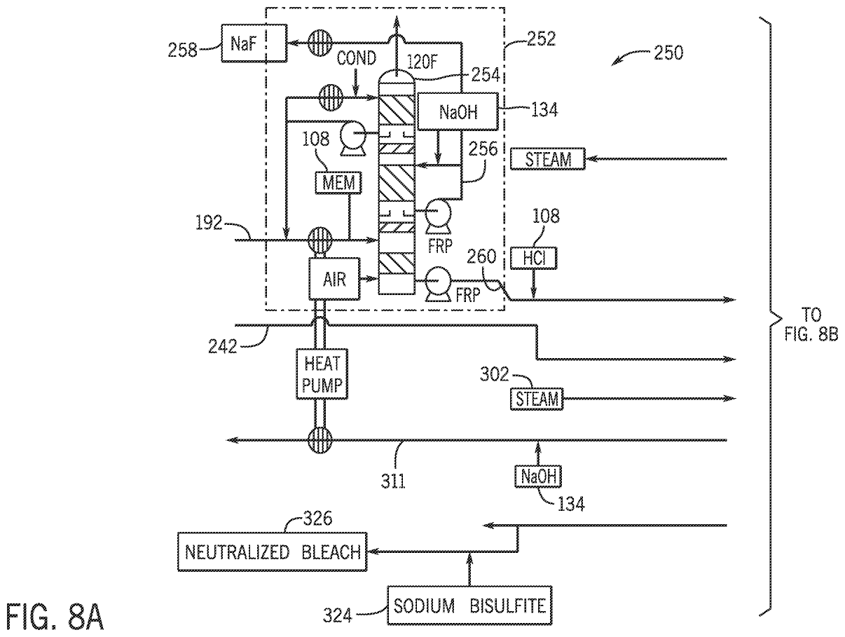

The resulting bromine containing chlorine product stream 242 (e.g., low purity chlorine stream having approximately 95 wt % chlorine, 5 wt % bromine) may be used in a bromine recovery system, where the bromine is recovered and utilized as discussed below. An example of a bromine recovery system is shown in FIGS. 8A and 8B.

FIG. 8 (e.g., FIGS. 8A and 8B) is a block diagram of an embodiment of a bromine recovery system 250 that may be employed within the desalination system of FIG. 1. For example, the bromine recovery system 250 may be downstream of the magnesium recovery system, the chlorine scrubber 230 described with respect to FIG. 7, the boron recovery system 166, or a combination thereof. In the depicted embodiment, the bromine recovery system 250 includes an air stripping unit 252 that receives a purge brine solution 192. The brine may generally be a brine with a portion of the sodium chloride removed (e.g., the purge brine or brine solution as shown). The purge brine solution 192 may be treated with HCl 108 and stripped with air in the stripper 254 to remove fluoride from the purge brine as HF which is absorbed in an internal absorber section with a recirculating NaOH solution 256 to produce a sodium fluoride (NaF) solution 258, thereby producing a low fluoride, bromide purge brine stream 260 avoiding HF corrosion issues in the downstream brome recovery system. A pump around condenser treats the scrubbed wet air from the NaOH absorber section to recover a portion of the water vapor as condensate recycle to the stripper feed and ensure that no residual caustic or sodium fluoride solution remains in the effluent air stream 254. Additionally, the bromine recovery system 250 includes a first distillation column 290 (e.g., a bromine stripper), a condenser and reflux drum 292, a second reflux drum 293, a stripper reflux drum scrubbing system 299, and a second distillation column 296.

The bromine stripper (e.g., the first distillation column 290) receives chlorine 242, HCl 108, NaOH 134, and the bromide purge brine stream 260, and produces a first bromine output 308. In the depicted embodiment, the chlorine 242 (e.g., chlorine gas) is fed to a bottom portion 300 of a middle packed section 301 of the bromine stripper 290, and steam 302 is fed to the bottom packed section 304. The chlorine gas reacts with the bromide in the bromide purge brine 260, converting a majority of the bromide in the bromide purge brine 260 (e.g., greater than 80%) to bromine and producing dissolved chloride in the falling brine. The steam strips the bromine, trace amounts of HF, and excess chlorine out of the brine, thereby producing a crude bromine water vapor stream, which is routed to a demister pad 306 to produce a first bromine output 308 that is fed to the bromine stripper condenser and reflux drum 292.

The bromine depleted, chloride enriched, partially stripped brine stream from the middle packed section 301 is routed to the bottom packed section 304 along with low pressure (e.g., between approximately 5 to approximately 10 psig) steam 302. The low pressure steam (e.g., the steam 302) substantially strips any residual bromine, chlorine, and HF out of the bromine depleted, chloride enriched brine stream, producing a lean brine stream suitable for recycling back to the sodium chloride or potassium chloride crystallizer section after addition of NaOH to adjust the pH to neutral (e.g., between 6-8). Sufficient acid (e.g., HCl 108) is added to the feed (e.g., bromide purge brine 260) such that the pH of the first bromine output 308 to the bromine stripper condenser and reflux drum 292 is reduced to less than approximately 2, thereby ensuring essentially all of the chlorine in the brine (e.g., the first bromine output 308) exists as free chlorine, which may be completely stripped from the product brine by the chlorine scrubber 295.

A reflux water stream 312 from the bromine stripper reflux drum 292 is routed to the demister pad 306, and purge water 310 from the chloride scrubber 295 (e.g., containing sodium hypobromite and sodium hypochlorite) is to the top packed section between the demisted pad 306. The crude bromine vapor of the second bromine output 310 strips out most of the bromine, chlorine, and HF into the enriched crude bromine vapor stream 308, thereby generating enriching the first bromine output 308. The enriched crude bromine vapor stream 308 is routed to the bromine stripper condenser 314.

The output of the boric acid recovery system 166 may include bromine (e.g., in the ionic form as sodium bromide salt) and/or trace amounts of fluoride (e.g., 1-10 mg/l). At least in some instances, a purge stream from a sodium chloride or potassium chloride crystallizer may be acidified with acid (e.g., HCl 108) and fed to the top of the middle packed section 301 to enable the stripped brine 309 to recycle back to the crystallizers (e.g., 202). In some embodiments, the first distillation column 290 may operate under low pressure (e.g., 9 psia and between approximately 180 to approximately 200 F). As such, the low-pressure conditions may substantially reduce or eliminate bromine and chlorine leakage, and facilitate use of a polyvinylidene fluoride or polyvinylidene difluoride (PVDF) lined fiberglass reinforced polymer (FRP) stripping vessel with PVDF packing and demister pad. The reduced pH converts the fluoride to fluorosilicic acid and hydrofluoric acid (HF), which may be stripped by the stream and/or crude bromine, as discussed herein. Partially stripped reflux water from the bottom of the top packed section mixes with the feed brine at the top of the middle packed section to generate a enriched crude bromine vapor stream 308 (e.g., wet bromine vapor).

The wet bromine vapor (e.g., the first bromine output 308) with the chlorine and HF impurities is routed to a SiC tubed condenser 314, which uses higher pressure open loop cooling water to condense the vapor and cool the liquid to 100 F. The reflux drum 292 operates under low pressure (e.g., 10 psia). In the reflux drum the bromine and water form two liquid phases, water on top and wet bromine on the bottom. The water phase from the brine stripper reflux drum is returned to the top of the distillation column (e.g., below 306).

The enriched crude bromine vapor stream (e.g., the first bromine output 308) is routed to a cooling water condenser 314, which condenses most of the feed vapor stream. In some embodiments, the cooling water condenser may include silicon carbide (SiC) tubes which condense most of the feed vapor stream by cooling the mixture to approximately 100 F at 9 psia. Air leakage and a portion of the more volatile HF and chlorine leave the top of the stripper reflux drum 292 and are routed to a scrubbing system. The condensed water and bromine phases are decanted in the bromine reflux drum 292 to produce a crude liquid bromine stream 318 and a bromine water stream 309. The bromine water stream 309 is mixed with a recycle bleach stream 309a from the first scrubber (e.g., the chlorine scrubber 295) and is fed to below of the demister pad section 306. The crude bromine liquid stream 318 containing dissolved chlorine, HF, and water is routed to the bottom of a bromine distillation reflux drum 293.

Any air leakage and a portion of the more volatile HF and chlorine leave the top of the stripper reflux drum 292 and are routed to an eductor where they are mixed with liquid from a recirculating alkaline scrubber (e.g., chloride scrubber 295), which converts most of the chlorine vapor to soluble sodium hypochlorite, sodium chloride, and water, and converts most of the HF to sodium fluoride and water. Desalinated water and sodium hydroxide are added to the circulating scrubber loop to limit sodium hypochlorite concentration to less than 20 wt %. A purge hypochlorite stream 321 is taken from the first scrubber (e.g., chloride scrubber 295). A portion 323a is routed to the return reflux bromine water stream 307 (e.g., via an additional chlorine scrubber), and the remainder 323b sent to the bleach tank to purge fluoride from the system.

The air from the chlorine scrubber 295 (e.g., from leakage described above) with trace amounts of chlorine and HF is routed to a second eductor on a circulating double wall atmospheric high density poly ethylene (HDPE) bleach tank. The residual chlorine is converted to sodium hypochlorite, sodium chloride, and water, and the residual HF is converted to sodium fluoride and water. Sodium hydroxide and water are added to the circulating bleach tank loop to limit the sodium hypochlorite concentration to less than 10 wt % to substantially reduce or eliminate hypochlorite tank emissions from the emitted double scrubbed air. The bleach stream 322 from the second scrubber tank (e.g., distillation column 296) containing sodium hypochlorite, sodium chloride, sodium fluoride, and water is recycled back to the tail brine processing system, described with respect to FIG. 9, where it is used to periodically clean the microfiltration (MF) membrane system (e.g., via a stream 322). All or a portion of the bleach stream from the second scrubber tank (e.g., distillation column 296) may also be routed to provide chlorination and fluoridation of the product of a filtration system. The double wall storage tank is of sufficient size to hold the bleach solution between cleanings. Alternatively, sodium bisulfite 324 may be mixed with the bleach to neutralize, thereby forming a neutralized bleach stream 326 that includes sodium chloride and sodium sulfate.

Crude bromine 318a from the bottom of the bromine distillation reflux drum 293, containing chlorine, HF, and water is routed to the top of the bromine distillation column 296 operating at low pressure (e.g., 15 psig). A reboiler with tantalum tubes or tantalum coated welded plates may use an internal closed loop 10 psig steam system (below column pressure) boils the bromine in the bottom of the distillation column to produce the column pressure. 50 psig steam from an external source may be used to generate the 10 psig closed loop steam. A small makeup demineralized (e.g., demin) and deaerated water steam and a small liquid purge to the closed loop cooling water system is used to maintain low closed loop boiler feed water conductivity. A small vapor purge to a higher pressure open loop cooling water condenser is taken to substantially reduce or eliminate buildup of non-condensibles. The condensate from the condenser is routed to the chlorine scrubber tank described above with respect to FIG. 7. A pH or conductivity instrument in the closed loop low pressure steam system (condensate from reboiler) may be used to detect a bromine leak into the closed loop steam system.

Although bromine has approximately four times the vapor pressure of water at the distillation conditions (e.g., vapor has a 4/1 Br₂/H₂O molar ratio), sufficient bromine is boiled in the reboiler (e.g., between approximately 4% to approximately 8%) to remove the small amount (e.g., less than approximately 1000 ppm, and less than approximately 0.9 mol %) of water dissolved in the feed crude bromine stream. Increased column temperature decreases the Br₂/H₂O vapor ratio; however, the bromine temperature in the bottom of the column is less than approximately 180 F at the 10-15 psig typical distillation column pressure for polyvinylidene fluoride (PVDF) lined fiberglass reinforced plastic (FRP), which may be more effective than the alternative glass lining at the higher temperature.

In addition to the lower vapor pressure water, the distillation column 296 may also remove essentially all the higher vapor pressure chlorine and HF at an increased reboiling ratio sufficient to remove the dissolved water. The purified bromine 325 from the bottom of the distillation column 296 is routed to a low pressure (e.g., below column pressure) closed loop cooling water tantalum tubed or tantalum coated welded plate exchanger. The closed loop cooling water is cooled with higher pressure chilled water or open loop cooling water. The closed loop cooling water system may have a small makeup stream from the closed loop low pressure steam system blowdown and a small blowdown stream to the chlorine scrubber. A pH or conductivity instrument in the closed loop cooling water may be used to detect a bromine leak into the closed loop cooling water.

The cooled (e.g., approximately 100 F), pressurized, purified (e.g., >99% purity), and dried (e.g., <100 ppm water) bromine from the product cooler may be routed directly into lead lined tanker trucks or isotanks (containerized tanks). A vapor return line from the trucks or isotank may be routed to the distillation reflux drum which is under vacuum (10 psia), thereby substantially reducing any potential tanker truck or isotank leaks.

The effluent vapor 319 from distillation column 296 is routed to an SiC tubed condenser using closed loop cooling water as described above to produce bromine and water condensate stream which is routed to bromine distillation reflux drum 293. The bromine and water separate in the reflux drum into a bromine water phase (top) and a crude bromine phase (bottom) which mixes with the crude bromine from the bromine stripper 318 forming 318a which is pumped to the distillation column 296 as described above. The small flow of bromine water containing less than approximately 3.5 wt % bromine (e.g., less than approximately 0.01 wt % of the feed bromine to the distillation column) from the reflux drum may be routed to the liquid sump of a chlorine scrubber. The closed loop steam purge condensate may also be routed to the liquid sump of the chlorine scrubber. The vapor from the reflux drum may be routed to an eductor on a circulating loop of a distillation chlorine scrubber. Sodium hydroxide may be added to the circulating loop to maintain a basic scrubber liquid pH (e.g., approximately 11), which may cause the bromine to be converted to sodium hypobromite bleach and sodium bromide, chlorine to be converted to sodium hypochlorite and sodium chloride, and HF to be converted to sodium fluoride. The small amount of vapor from the distillation chlorine scrubber may be routed to the vapor line from the chlorine scrubber on the bromine stripping column. A liquid purge bleach stream may be taken from the distillation scrubber to the double wall bleach tank. Desalinated makeup water is added to establish a bleach concentration less than 10 wt % NaOCl equivalent to substantially reduce or eliminate emission of bleach vapor from the double wall bleach tank vent.

In some embodiments, the bromine distillation column (e.g., the second distillation column 296) may not operate under low pressure (e.g., vacuum). Accordingly, to substantially reduce or eliminate vapor leaks from impacting the other water processing system sections, the bromine distillation section (e.g., including the second distillation column 296) may be contained at a relatively low pressure (e.g., below atmospheric pressure). A standard packed bed or spray type bromine scrubber using a circulating caustic solution (e.g., pH approximately between 11 to approximately 12) may be used to treat the air from the enclosure. A blower on the discharge of the scrubber creates a slight vacuum (e.g., 1-10 inches water) within the scrubber and enclosure. Bromine gas detectors within the enclosure may be used to detect leaks within the enclosure, thereby enabling the bromine distillation column to be remotely shutdown, fully drained, and the enclosure ventilated before entry to fix the leak. A small purge stream from the scrubber may be taken to the double wall bleach tank to maintain level in the scrubber sump.

The divalent ion rich (e.g., Ca, Mg, SO₄) nanofiltration (NF) concentrate streams from full recovery desalination of seawater, brackish water, and some produced waters contains a supersaturated concentration of dissolved gypsum. A gypsum antiscalant 149 may be used in the NF units to substantially reduce or eliminate NF membrane scaling while enhancing recovery of the monovalent NF permeate stream. Enhancing the NF permeate stream facilitates further treatment in reverse osmosis and brine concentration membranes to produce desalinated water and concentrated monovalent salt brine. However, the use of NF antiscalant may negatively affect the downstream gypsum recovery section used to treat the NF concentrate since the antiscalant contaminates the crystallization growth sites. This may effectively increase the gypsum solubility by up to 200% of the gypsum saturation index without antiscalant.

Dissolved sulfate in divalent NF concentrate may be nearly completely removed (e.g., >99%) in the gypsum recovery section. Lime (calcium hydroxide) or dolomitic lime (calcium, magnesium hydroxide) may be added to the brine from the gypsum recovery system to recover high purity magnesium hydroxide. If nearly all the sulfate remains upstream of the magnesium hydroxide recovery section, then the residual sulfate may react with the calcium in the added lime to produce a gypsum impurity in the magnesium hydroxide product. High magnesium hydroxide purity is desirable because the higher the magnesium hydroxide purity the higher the price. The largest and most profitable market for magnesium hydroxide is as a refractory feedstock, and impurities cause the refractory to breakdown prematurely.

Monovalent ions (e.g., Na, Cl, K, Br) and water are also in the NF concentrate stream 24. These components may be separated into a monovalent recycle stream (e.g., the streams 96 and 94) so that the water and monovalent ions may be returned to the monovalent ion and water recovery section of the water processing system (e.g., the portion of the desalination system 10 that is downstream of the RO system 38, including the monovalent mineral recovery system 58), thereby enabling the efficient recovery of desalinated water and production of substantially pure monovalent components (e.g., NaCl, KCl, Br₂) as industrial minerals and chemicals. An evaporator may be used to recover the water and produce gypsum even with the antiscalant present; however full evaporation recovery of all the water may incur a high capital and energy cost. In addition, the evaporator may not separate and recover the monovalent components.

Furthermore, the purge brine from the NaCl salt crystallizer is routed to a bromine recovery system. The feed brine to the bromine recovery unit may be prestripped at a pH of 2 using HCl addition in an air stripper with an integral caustic scrubber and pump around condenser. This may remove the fluoride as HF and then recover the fluoride as sodium fluoride which may be used to remineralize the desalinated water. Most of the fluoride is removed (greater than 80%), which reduces the risk of HF attack on the tantalum clad heat exchangers. The remaining fluoride is removed with the bleach+NaF purge brine stream. A portion of this stream is routed periodically to the seawater pretreatment system for disinfection, and the remainder is neutralized with self-produced sodium bisulfite and routed to the MV tail brine NF.

A heat pump is used to cool the feed brine and reheat the bromine stripped brine. Most of the hot stripped brine is recycled back to the NaCl salt crystallizer, and a small amount (e.g., 5-6%) of the feed to the salt crystallizer is cooled by preheating the brine feed (e.g., thereby transferring heat) to the crystallizer and routed to the tail brine NF, which is discussed in more detail below.

### MV Tail Brine Processing

FIG. 9 is a block diagram of an embodiment of an MV Tail brine processing system 330 that may be used with the desalination system 10. In the illustrated embodiment, the MV tail brine processing system 330 receives the NaCl crystallizer purge stream 332 (e.g., the NaCl stream 424), the MV NF concentrate 64, and the bromine purge neutralized bleach 326. At least a portion of these streams may be routed to the MV tail brine NF unit 334. The elevated sulfate content (e.g., due to the sulfuric acid added from the NF permeate Recycle and SWRO system discussed in FIG. 3) in the MV NF concentrate 64 may enable an NF unit 334 of the MV tail brine processing system 330 to remove nearly all the residual calcium and magnesium from the tail brine streams, thereby generating the MV NF permeate stream 336 and a sulfate purge stream 338. The sulfate purge (e.g., including calcium sulfate and magnesium sulfate) may be recycled back to the recycle seawater system.

In the illustrated embodiment, the MV tail brine processing system includes a boric acid ion exchange (e.g., BIX) system 340. As generally discussed with respect to FIG. 5, the BIX system 340 may include an ion exchange resin that facilitates the removal of boron from a brine stream, thereby generating a boron rich stream 342 (e.g., which may be provided to the boron tank 168 of the boron recovery system 166 described with respect to FIG. 5). As such, the BIX system 340 may remove boric acid from the NF permeate, and the boric acid rich brine may be routed to the boric acid recovery system 166, such as the boric acid recovery system discussed above with respect to FIG. 5. The brine stream 344 (e.g., not containing the boric acid) may then be preheated using condensate 346 provided to a heat exchanger 348 and routed to a recycle NaCl MVR 350 (e.g., MVR Crystallizer) or a multieffect NaCl crystallizer (e.g., multieffect Crystallizer). The recycle NaCl MVR 350 generates a recycle salt 352, which may have an elevated bromine and potassium content and, as such, may be recycled to a feed mix tank to redissolve the NaCl, bromine, and potassium within the recycle salt 352. This may enable the bromine to be recovered in the bromine recovery system 250, as described with respect to FIGS. 8A and 8B, and the potassium to be recovered in the vacuum crystallizer described below. The recycle NaCl MVR 350 may generate brine output containing potassium, which may be crystallized by the crystallizer 353 to generate a KCl stream 354 and a condensate 356. The crystallizer 353 may generate a tail brine stream 358 that may be stored in the storage tank 359 or provided to a microfiltration based softener unit 360 to remove residual magnesium as magnesium hydroxide and calcium as calcium carbonate with the addition of NaOH and CO₂ and generate a softened brine MF permeate stream 364. The MF permeate stream 364 may be directed to a lithium carbonate (Li₂CO₃) settler 366 to produce Li₂CO₃ 368 and an additional NaCl brine stream 370, which may be combined with the NaCl crystallizer purge stream 332. As shown, NaOH 134 and/or HCl 108 maybe provided upstream and/or downstream of the MF unit 360 to adjust the pH. Additionally, CO₂ 152 may be provided upstream the MF unit 360 to increase the amount of Li₂CO₃ 368 produced.

### Potassium Chloride and Derivatives

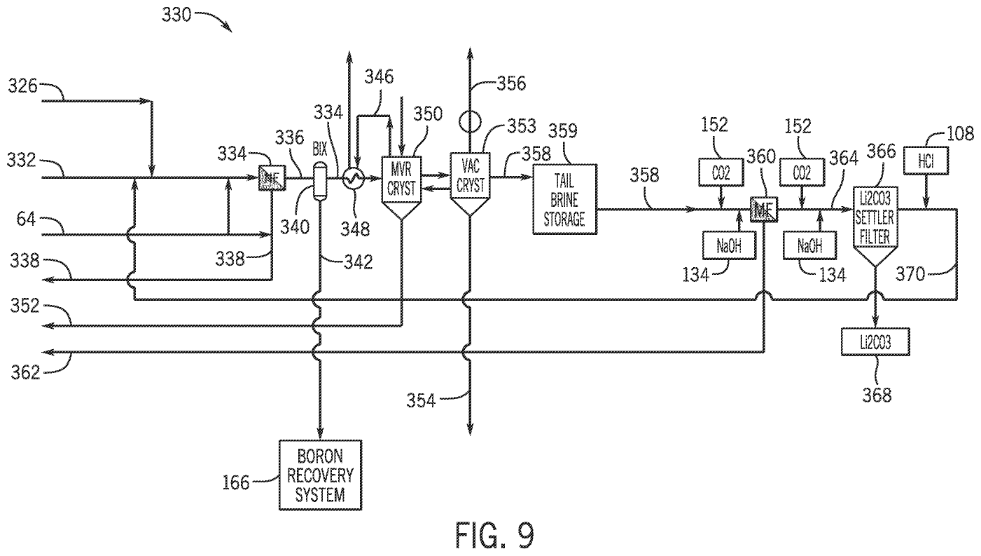

A purge stream 354 (e.g., KCl stream shown in FIG. 9) from the recycle NaCl crystallizer may substantially reduce or prevent bulk potassium crystallization. The hot (e.g., 106-110° C.) purge brine which is nearly saturated with potassium chloride (e.g., 95-99%) is routed to a vacuum crystallizer operating at 45 C, which produces potassium chloride (e.g., 98-99% purity) with low Ca (e.g., less than 2 mg/l), low Mg (e.g., less than 2 mg/l), and low SO₄ (e.g., less than 2 mg/l). This enables the potassium chloride from the hot purge brine to be used in a chlor-alkali plant to produce potassium hydroxide, hydrogen, and chlorine without residual solids or waste brine. The potassium hydroxide may optionally be mixed with self-produced sulfuric acid to produce potassium sulfate fertilizer, as shown in the example of the potassium sulfate production system 371 of FIG. 10.

As illustrated, the potassium sulfate production system 371 includes a sulfuric acid production unit 372, a chlor-alkali production unit 374, and a potassium sulfate production unit 376. The sulfuric acid production unit 372 receives an oxygen stream 378, sulfur 380, and a condensate 382, which react to form a sulfuric acid stream 384. Additionally, the sulfuric acid production unit 372 may produce power 386 and steam 388, which may be utilized by components of the desalination system 10.

The chlor-alkali production unit 374 receives a potassium chloride stream 390, such as the KCl stream 354 generated by the crystallizer 353 discussed with respect to FIG. 9, and a condensate stream 392. As illustrated, the potassium sulfate production unit generates the condensate stream 392; however, other condensate streams produced by the desalination system may be utilized by the chlor-alkali production unit 374. In any case, the chlor-alkali unit 374 generates a potassium hydroxide (KOH) stream 394 using the KCl stream 390 and the condensate 392. Additionally, the chlor-alkali production unit 374 generates an H₂ stream 396, a Cl₂ and HCl stream 398, and a Cl₂ and Br₂ stream 400. It should be noted that the Cl₂ and HCl stream 398 and/or the Cl₂ and Br₂ stream 400 may be provided to the bromine removal system 250 described with respect to FIG. 8. Furthermore, the potassium sulfate production unit 376 generates potassium sulfate (K₂SO₄) using the KOH stream 394 and the H₂SO₄ stream 384.

In some embodiments, the hydrogen from the chloralkali production unit may be converted to ammonia and the ammonia converted to nitric acid. The nitric acid may then reacted with the potassium hydroxide similar to the potassium sulfate above.

The purge brine from the vacuum crystallizer may be routed to a second MF (e.g., back pulse filter) softener to remove residual calcium and magnesium and then to a reactor, settler, filter system where CO₂ and NaOH are added for recovery of lithium carbonate. The overflow from the lithium carbonate settler may be acidified with HCl and recycled to the tail brine NF feed.

### PV Brine Processing

The SWNF concentrate and the recycle PV NF concentrate are fed to the gypsum recovery system described in PCT Application PCT/US2020/045493, which is hereby incorporated by reference in its entirety. The brine from gypsum recovery is heated to approximately 55 C using PV evaporator condensate and deaerated in a spray type vacuum deaerator. Limiting the temperature to 55 C substantially reduces or avoids gypsum scaling without antiscalant use, which is undesirable since it increases gypsum solubility and sulfate content in the brine routed to magnesium recovery.

Hot condensate from gypsum brine evaporation is routed to a condensate flash drum where it is used to produce near atmospheric (0.8 bar) steam. A heat pump is used to extract heat from the product condensate to increase steam production and cool the condensate. The steam from the condensate flash drum is compressed and routed to the MVR evaporator as supplemental steam to compensate for the MVR feed which is not fully preheated to avoid gypsum scale. The MVR evaporator is operated as a gypsum seeded MVR with a gypsum content in the brine of approximately 1-4 wt % solids. This causes the residual gypsum to crystallize onto the slurry particles and not on the heat exchanger tubes. Multiple MVR evaporators may be used in series to reduce boiling point rise and reduce compressor discharge pressure.

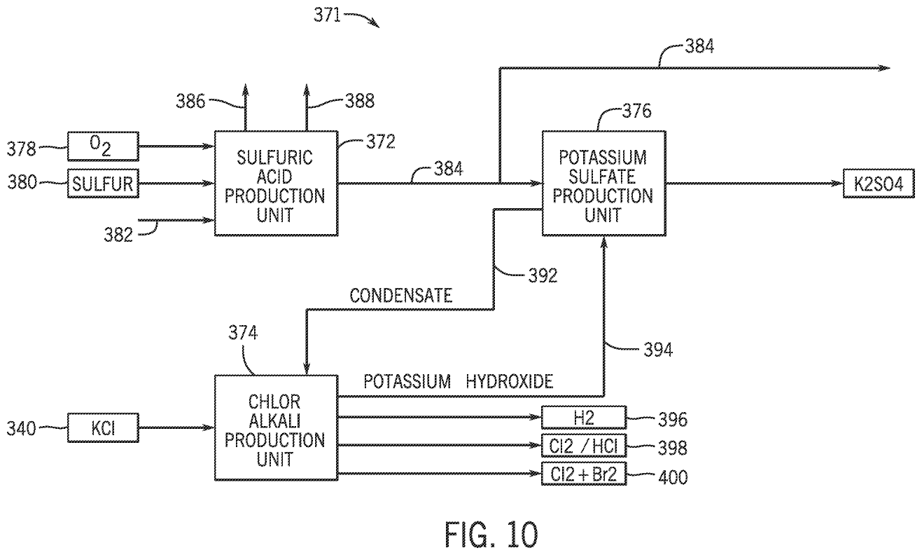

The PV brine from the gypsum seeded MVR evaporators is routed to either a heat pump crystallizer or a multieffect crystallizer. An example of a crystallizer section 80 is shown in FIG. 11. In some embodiments, the crystallizer section 80 may include an MVR crystallizer. As illustrated, the crystallizer section 80 includes multiple crystallizers 402.

The first heat exchanger 403a places the gypsum slurry concentrate stream 78 in thermal communication with steam 404 (e.g., low pressure steam, 144° C., 4 bar, produced by a CSP system). A first pump 405a directs the heated gypsum slurry concentrate stream 78 to the first crystallizer 402a, which further concentrates the heated gypsum slurry concentrate stream 78, thereby producing a first gypsum slurry concentrate stream 406. Cooled steam 408 may be vented and/or utilized by other components of the desalination system 10.

Furthermore, the second heat exchanger 403b places the first gypsum slurry concentrate stream 406 in thermal communication with a first vapor stream 410a generated by the first crystallizer 402a. A second pump 405b directs the heated first gypsum slurry concentrate stream 406 to the second crystallizer 402b, which further concentrates the heated first gypsum slurry concentrate stream 406, thereby producing a second gypsum slurry concentrate stream 412. The cooled first vapor stream 410a may be vented and/or utilized by other components of the desalination system 10.

Furthermore, the third heat exchanger 403c places the second gypsum slurry concentrate stream 412 in thermal communication with a vapor stream 410b generated by the second crystallizer 402b. A third pump 405c directs the heated second gypsum slurry concentrate stream 412 to the third crystallizer 402c, which further concentrates the heated second gypsum slurry concentrate stream 412, thereby producing a third gypsum slurry concentrate stream 414. The cooled second vapor stream 410b may be vented and/or utilized by other components of the desalination system 10.

Furthermore, the fourth heat exchanger 403d places the third gypsum slurry concentrate stream 414 in thermal communication with a vapor stream 410c generated by the third crystallizer 402c. A fourth pump 405d directs the heated third gypsum slurry concentrate stream 414 to the fourth crystallizer 402d, which further concentrates the heated third gypsum slurry concentrate stream 414, thereby producing the recycle gypsum slurry filtrate stream 86, which may be used to produce additional gypsum 68. As illustrated, CaCl₂ brine 82 may be added to the third gypsum slurry concentrate stream 414 to facilitate producing gypsum. The cooled second vapor stream 410d may be vented and/or utilized by other components of the desalination system 10. In addition, the recycle gypsum slurry filtrate stream 86 may be provided to a vacuum belt filter to generate solid gypsum.

The high boiling point elevation (e.g., greater than approximately 10 C) may be achieved via the electrically power heat pump based crystallizer or steam based multieffect crystallizer. A 10-20 wt % gypsum slurry from the final evaporator is routed back to the gypsum recovery system where a vacuum belt filter recovers the gypsum and routes the filtrate to a tank that feeds the magnesium recovery section.

### Magnesium Recovery

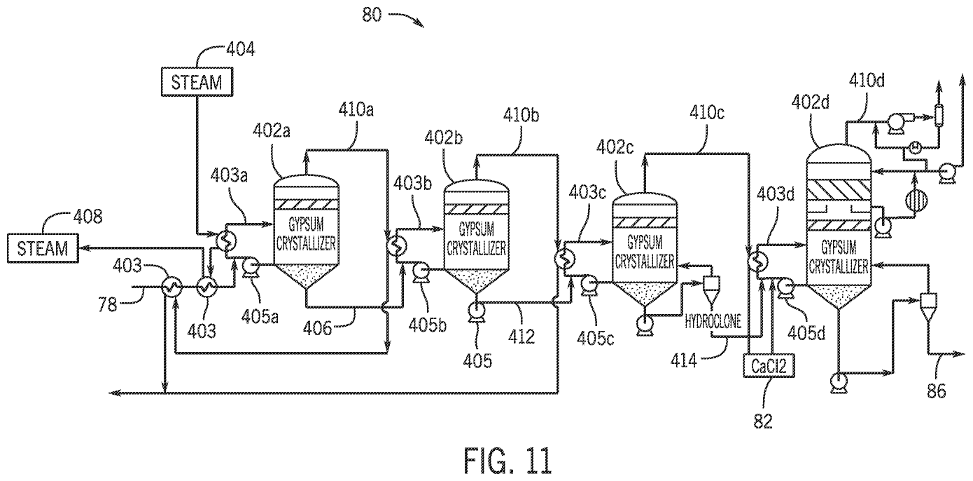

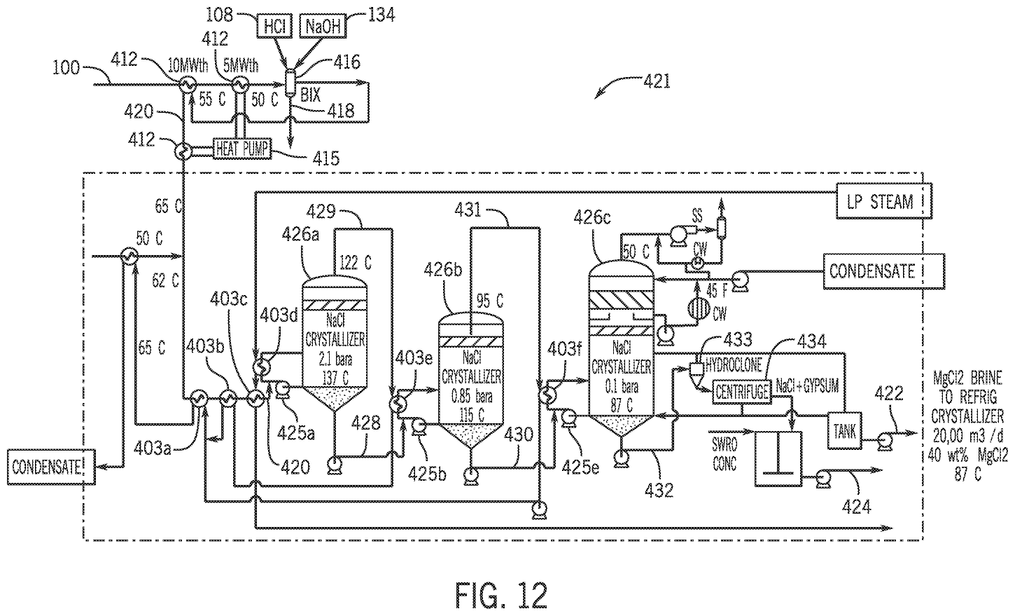

The magnesium chloride rich PV brine from the feed tank 104, as described with respect to FIG. 1, may be cooled to 50° C. using a feed product exchanger and a feed product heat pump, and a boric acid ion exchange system is used to remove boric acid. The reheated brine is fed to either a heat pump based crystallizer or a multieffect crystallizer. An example of a multieffect crystallizer (e.g., NaCl crystallizer) that may be used to concentrate MgCl₂ brine is shown in FIG. 12. As shown in the illustrated embodiment, the MgCl₂ brine stream 100 is place in thermal communication with one or more heat exchangers 403 heated by a heat pump 415. Furthermore, a BIX 416 receives the MgCl₂ brine stream 100 and may extract boron as boric acid from the MgCl₂ brine stream 100, thereby generating a boric acid stream 418. An MgCl₂ stream 420 (e.g., with boron removed) is provided to an MgCl₂ concentration system 421 that generally generates a MgCl₂ concentrate stream 422 and a NaCl stream 424. The MgCl₂ concentrate stream 422 may be crystallized from an NaCl containing solution using the techniques described below with respect to FIG. 13, and the NaCl stream 424 may be provided to the NF system 20 to filter out the NaCl.

As shown, one or more heat exchangers 403a, 403b, 403c, and 403d place the MgCl₂ stream 420 in thermal communication with steam 404 (e.g., low pressure steam, at 144° C. and 4 bar, produced by a CSP). A first pump 425a directs the heated MgCl₂ stream 420 to a first crystallizer 426a, which further concentrates the MgCl₂ stream 420, thereby producing a first MgCl₂ concentrate stream 428. The vapor stream 429 may be vented and/or utilized by other components of the desalination system 10.

Furthermore, a fifth heat exchanger 403e places the first MgCl₂ concentrate stream 428 in thermal communication with the vapor stream 429 generated by the first crystallizer 426a. A second pump 425b directs the heated first MgCl₂ concentrate stream 428 to a second crystallizer 426b, which further concentrates the MgCl₂ concentrate stream 428, thereby producing a second MgCl₂ concentrate stream 430. The cooled first vapor stream 431 may be vented and/or utilized by other components of the desalination system 10.

Furthermore, a sixth heat exchanger 403f places the second MgCl₂ concentrate stream 430 in thermal communication with the cooled first vapor stream 431 generated by the second crystallizer 426b. A third pump 425c directs the heated second MgCl₂ concentrate stream 430 to a third crystallizer 426c, which further concentrates the heated second MgCl₂ concentrate stream 430, thereby producing a third MgCl₂ concentrate stream 432. As illustrated, the third MgCl₂ concentrate stream 432 may be further concentrated using a hydroclone 433 and a centrifuge 434, thereby generating the MgCl₂ concentrate stream 422, which may be provided to the downstream surface cooled crystallizer.

NaCl is crystallized out of the brine, and a centrifuge on the final evaporator (e.g., third crystallizer 426c) is used with brine NF permeate washing to produce a high purity NaCl salt (e.g., greater than 95%) which contains dissolved residual gypsum. The salt is redissolved in a small portion of SWRO concentrate to produce a near saturated NaCl brine (23-25 wt %).

The NaCl brine is routed to an NF unit, which produces a concentrated NaCl brine permeate stream which is routed to the concentrated MV brine tank (e.g., SWRO concentrate evaporator product tank). The NF concentrate from the first stage is diluted to 10 wt % with condensate and routed to a second NF to produce a dilute NaCl brine permeate which is routed to the dilute MV brine tank (e.g., SWRO concentrate evaporator feed tank). The NF concentrate from the dilute brine NF is recycled to the feed to the gypsum recovery system.

As generally mentioned above, the magnesium recovery system 88 generates a MgCl₂ brine stream 100, which may be concentrated and used to generate magnesium metal. To illustrate concentrating the MgCl₂ in the MgCl₂ brine stream 100, FIG. 13 is a schematic diagram of an embodiment of a sodium chloride filter system 438 that may be included in the NaCl crystallizer described above with respect to FIG. 12. In certain embodiments, the sodium chloride filter system 438 may receive a pretreated MgCl₂ stream 100, the MgCl₂ brine stream 422, other suitable MgCl₂ brine streams, or a combination thereof. In any case, the MgCl₂ brine stream 422 may be heated, thereby generating a hot (e.g., 85-90° C.)magnesium chloride brine and routed to a surface cooled crystallizer operating at 30-40° C. The reduced temperature of the surface cooled crystallizer may cause a portion (e.g., between approximately 40-60%) of the dissolved MgCl₂ in the feed to crystallize from the brine, thereby generating the magnesium chloride stream 422 (e.g., MgCl₂-6H₂O slurry stream). The product slurry (e.g., the magnesium chloride stream 422) is pumped to a vacuum belt filter equipped with a feed hydroclone 440 which separates and recycles the filtrate 441 and produces a washed (e.g., using condensate 442), dried (e.g., using a heated air flow 444), high purity (e.g., greater than approximately 97%) MgCl₂-6H₂O solid 446, thereby meeting the requirements for a magnesium metal electrolytic cell feed. The MgCl₂-6H₂O solid 446 is routed to a recirculated mix tank 448 equipped with a low pressure steam heater 450, which melts the filter cake (e.g., the solid 446) and produces a hot (120° C.) 45 wt % MgCl₂ brine slurry (e.g., MgCl₂ concentrate stream) 452.

The 45 wt % MgCl₂ brine slurry is routed to a spray dryer and then a recirculated HCl dryer, such as the MgCl₂ brine dryer described above with respect to FIG. 6. Both dryers are heated by molten salt from the CSP cogen, as described above with respect to FIG. 6. The dried MgCl₂ may be routed to magnesium production based on the Alliance Magnesium (U.S. Pat. No. 10,563,314) or equivalent electrolytic process. Purge electrolyte (e.g., approximately 60% NaCl, approximately 25% MgCl₂, and approximately 15% CaCl₂)) from the electrolytic process is dissolved in condensate and recycled back to the NaCl crystallizer (e.g., as described with respect to FIG. 12) in the magnesium recovery section.

The brine from the surface cooled crystallizer is routed to a reactor and settler system where lime or dolomitic lime is mixed with the magnesium chloride rich brine. This precipitates magnesium hydroxide from the brine and produces a concentrated (e.g., approximately 35 wt %) calcium chloride rich settler overflow stream which is routed to a calcium chloride brine tank. The calcium chloride brine is then recycled to gypsum recovery and the gypsum rich brine evaporators as described above. The recovery of MgCl₂-6H₂O in the surface cooled crystallizer is controlled to maintain the level in the calcium chloride brine tank to balance supply with demand. The magnesium hydroxide may be filtered, dried, and calcined using certain power based systems, as would be appreciated by one of ordinary skill in the art.

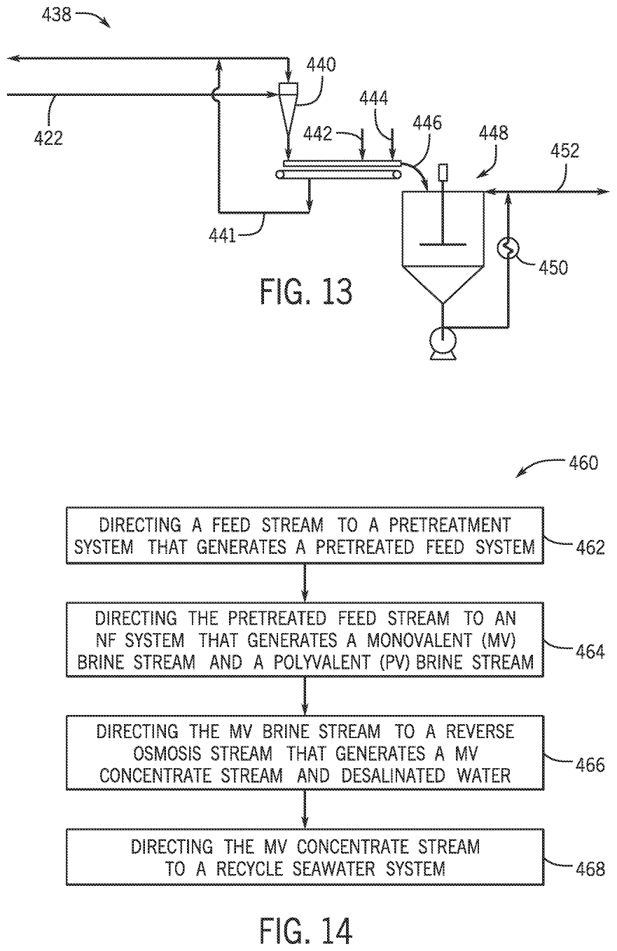

FIG. 14 is a flow diagram of an embodiment of a method 460 by which the desalination system generates certain minerals, as discussed herein. The method includes directing (block 462) a feed stream to a pretreatment system that generates a pretreated stream and a pretreated backwash stream. For example, as discussed above with respect to FIGS. 1 and 2, the pretreatment system 20 may be used to provide the pretreated backwash stream to a recycle stream system that provides water to components of the desalination system, such as NF system(s), when a flow rate threshold to the NF systems falls below a threshold.

Additionally, the method includes directing (block 464) the pretreated stream to a NF system that generates a PV stream and an MV stream. For example, as discussed above with respect to FIG. 3, the NF system includes one or more NF units that separate MV and PV ions within the pretreated stream. At least in some instances, the NF units may each be capable of filtering out different portions of PV ions, such as sulfate, due to a filter capability (e.g., a tight or loose filtering capability) of the NF units.

Additionally, the method includes directing (block 466) the MV stream to an RO system that generates desalinated water and an MV concentrate stream. Additionally, the method includes directing (block 468) the MV concentrate stream to an MV mineral recovery unit that generates MV minerals and an MV recycle stream. For example, as discussed herein, the MV mineral recovery unit may extract the MV salts from the MV concentrate stream and generate multiples streams, such as an MV recycle stream and an Mg(OH)₂ stream. In some embodiments, the MV recycle stream may be used as a makeup water stream for the NF system, as described herein. In some embodiments, the method 460 may include directing an NF filtrate to a gypsum removal system that generates gypsum and a PV recycle stream. In such embodiments, the PV recycle stream may also be provided to the recycle seawater system. Accordingly, the NF system may receive a brine stream containing both MV and PV ions (e.g., the recycle sea water stream 32) during periods of relatively low flow rate from the pretreated feed stream 18.

### Technical Effects

Accordingly, the present disclosure relates generally to a desalination system that utilizes recycle stream(s) (e.g., recycle seawater stream(s)) to improve the amount of minerals extracted from a brine stream. Certain technical effects of the present disclosure include a recycle seawater system that may be used to recover and blend recycle and upset brine streams into a recycle seawater system that enables recycle of these streams without substantially impacting the operation of the sensitive NF and RO membranes. Alternate power and steam based desalination systems are provided to enable the full recovery desalination system to be configured for either low cost green power or low cost CSP based green power and steam. The full recovery desalination system self-produces nearly all the feedstocks utilized. In some embodiments, the full recovery desalination system may utilize externally supplied sulfur to produce sulfuric acid for adjusting sulfate content in certain streams described herein (e.g., green steam and power fuel), lime or dolomitic lime, and minor amounts of antiscalant. As such, there may be no hydrocarbon fuels utilized and no CO₂ emissions. This may provide the high purity products that also avoid any carbon taxes. Recovering MgCl₂-6H₂O using evaporators, as described with respect to FIG. 13, and crystallizers (e.g., no added chemicals) may increase magnesium profitability because relatively low cost energy may be utilized and the high purity condensate byproduct may offset at least a portion of the cost of production. The high purity NaCl salt generated using the disclosed techniques may provide a price premium since it may be utilized for chlor-alkali customers and/or internal chlor-alkali production to substantially reduce or eliminate waste brine and solids streams. Furthermore, providing an onsite chlor-alkali plant may enable both chlorine purification (e.g., bromine removal) and recovery of the bromine contaminant as a high value bromine product. Further still, modifying the NF membrane types (e.g., using a tight NF membrane and a loose NF membrane), recycle methods, and recycle CaCl₂) brine flows may reduce the amount of expensive downstream MV brine treatment and PV brine treatment.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a water pretreatment system configured to receive a seawater stream and to generate a pretreated feed stream based on the seawater stream;
a nanofiltration (NF) system configured to receive the pretreated feed stream and to generate an NF permeate stream and an NF filtrate stream, wherein the NF permeate stream comprises monovalent salts, and the NF filtrate stream comprises divalent salts;
a reverse osmosis (RO) system configured to receive the NF permeate stream and to generate a RO concentrate stream and desalinated water;
a monovalent (MV) mineral recovery system configured to receive the RO concentrate stream and to generate a concentrated MV salt recycle stream; and
a recycle seawater system configured to generate a recycle seawater stream based on the MV salt recycle stream, wherein the recycle seawater system is configured to direct the recycle seawater stream to the NF system.

2. The system of claim 1, comprising a gypsum recovery system configured to receive the NF permeate stream, wherein the gypsum recovery system is configured to generate a polyvalent (PV) salt recycle stream and a PV stream, and the gypsum recovery system is configured to direct the PV salt recycle stream to the recycle seawater system;
wherein the recycle seawater system is configured to generate the recycle seawater stream based on the PV salt recycle stream.

3. The system of claim 2, comprising a magnesium recovery system, wherein the MV mineral recovery system is configured to generate a magnesium hydroxide stream, and the magnesium recovery system is configured to receive the magnesium hydroxide stream and to generate a magnesium chloride stream.

4. The system of claim 1, wherein a ratio between the seawater stream and the recycle seawater stream provided to the NF system is based on a flow rate threshold associated with the NF system.

5. The system of claim 1, comprising an NF permeate recycle seawater system configured to generate an NF permeate recycle stream based on a permeate generated by the NF system, wherein the NF permeate recycle seawater system is configured to direct the NF permeate recycle stream to the NF system.

6. The system of claim 1, comprising a sulfuric acid production system configured to receive a sulfur source and to generate sulfuric acid based on the sulfur source, wherein the sulfuric acid production system is configured to direct the sulfuric acid upstream of the NF system.

7. The system of claim 1, wherein the MV mineral recovery system is configured to generate a magnesium hydroxide stream.

8. The system of claim 1, comprising an sodium chloride (NaCl) crystallizer downstream of the MV mineral recovery system, wherein the NaCl crystallizer is configured to receive an NaCl brine stream and to generate NaCl having a purity greater than 95%.

9. The system of claim 8, wherein the recycle seawater system is configured to supplement the flow of the pretreated feed stream to the NF system.

10. A system, comprising:
a water pretreatment system configured to receive a seawater stream and to generate a pretreated feed stream based on the seawater stream;
a nanofiltration (NF) system configured to receive the pretreated feed stream, wherein the NF system comprises:
a first NF unit configured to generate an NF permeate stream and an NF filtrate stream based on the pretreated feed stream, wherein the NF permeate stream comprises monovalent (MV) salts, and the NF filtrate stream comprise polyvalent (PV) salts; and
a second NF unit configured to receive the NF filtrate stream and to generate an NF recycle stream, wherein the second NF unit is configured to direct the NF recycle stream upstream of the first NF unit;
a reverse osmosis (RO) system configured to receive the NF permeate stream and to generate an RO concentrate stream and desalinated water;
a monovalent (MV) mineral recovery system configured to receive the RO concentrate stream and to generate a concentrated MV salt recycle stream; and
a recycle seawater system configured to generate a recycle seawater stream based on the MV salt recycle stream, wherein the recycle seawater system is configured to direct the recycle seawater stream to upstream of the first NF unit.

11. The system of claim 10, wherein the first NF unit is configured to filter a first portion of sulfate salts present in the pretreated feed stream, the second NF unit is configured to filter a second portion of the sulfate salts present in the NF filtrate stream, and the first portion is less than the second portion.

12. The system of claim 10, comprising a gypsum recovery system, wherein the second NF unit is configured to generate a PV filtrate stream, and the gypsum recovery system is configured to receive the PV filtrate stream and to generate gypsum and a PV salt recycle stream;
wherein the recycle seawater system is configured to generate the recycle seawater stream based on the PV salt recycle stream and the MV salt recycle stream.

13. The system of claim 10, wherein the MV mineral recovery system is configured to generate a magnesium hydroxide stream.

14. The system of claim 13, comprising a magnesium recovery system configured to receive the magnesium hydroxide stream, wherein the magnesium recovery system is configured to generate a concentrated magnesium chloride hydrate stream based on the magnesium hydroxide stream.

15. The system of claim 10, wherein a ratio between the seawater stream and the recycle seawater stream provided to the first NF unit is controllable based on a flow rate threshold associated with the NF system.

16. The system of claim 10, wherein the first NF unit is configured to receive a sulfate stream.

17. A system, comprising:
a water pretreatment system configured to receive a seawater stream and to generate a pretreated feed stream based on the seawater stream;
a nanofiltration (NF) system configured to receive the pretreated feed stream and to generate a monovalent (MV) salt stream and a polyvalent (PV) salt stream, wherein the PV salt stream comprises calcium and sulfate ions;
a gypsum recovery system configured to receive the PV salt stream and to generate gypsum and a PV salt recycle stream; and
a recycle seawater system configured to generate a recycle seawater stream based on the PV salt recycle stream, wherein the recycle seawater system is configured to direct the recycle seawater stream to the NF system.

18. The system of claim 17, wherein the NF system comprises a first NF unit and a second NF unit; the first NF unit is configured to filter a first portion of sulfate ions present in the pretreated feed stream to generate the MV salt stream and an NF stream, the second NF unit is configured to filter a second portion of the sulfate salts present in the NF permeate stream to generate the PV salt stream, and the first portion is less than the second portion.

19. The system of claim 17, comprising a magnesium recovery system configured to generate a magnesium chloride stream based on the PV salt recycle stream.

20. The system of claim 17, wherein a ratio between the seawater stream and the recycle seawater stream provided to the NF system is controllable based on a predetermined flow rate threshold associated with the NF system.
